(19) United States
(12) Patent Application Publication
(10) Pub. No.: US 2008/0245248 A1
(43) Pub. Date: Oct. 9, 2008

(54) PRINTING METHOD, PRINTING APPARATUS AND LIQUID-CRYSTAL DISPLAY DEVICE USING THE SAME

(75) Inventor: Hideaki TAKAMATSU, Kanagawa (JP)

Correspondence Address: YOUNG & THOMPSON, 209 Madison Street, Suite 500, ALEXANDRIA, VA, 22314, US

(73) Assignee: NEC LCD TECHNOLOGIES, LTD., KANAGAWA (JP)

(21) Appl. No.: 12/100,213

(22) Filed: Apr. 9, 2008

(30) Foreign Application Priority Data
Apr. 9, 2007 (JP) 2007-102161

(51) Int. Cl. B41F 7/02

(52) U.S. Cl. 101/217; 101/492

(57) ABSTRACT

A printing method realizes good reproducibility of an ink pattern and facilitates both the alignment operation between a printing plate and a blanket and the alignment operation between the blanket and a substrate, enabling the printing with positional accuracy as high as the TFT substrate can be fabricated. The flat portion of the printing plate and the flat portion of the endless belt-shaped blanket are contacted in the state where the said flat portions are opposed. Then, the said flat portions are detached, forming an ink pattern on the flat portion of the blanket. Thereafter, the flat portion of the blanket and the flat portion of the substrate are contacted in the state where the said flat portions are opposed. Subsequently, the said flat portions are detached, transferring the ink pattern to the flat portion of the substrate from the blanket.

### BACKGROUND OF THE INVENTION

1. Field of the Invention

The present invention relates to a printing method, a printing apparatus, and a Liquid-Crystal Display (LCD) device and more particularly, to a printing method and a printing apparatus for forming an ink pattern on a blanket using a printing plate and for transferring the ink pattern to a substrate from the blanket, and a LCD device fabricated by using the printing method.

In this specification, the term “blanket” means a member or structural component on the surface of which an ink pattern is temporarily formed using a printing plate, and which is used for transferring the ink pattern thus formed to a target object. Typically, a “blanket” is produced by covering the surface of an elastic base cloth with an elastic material, such as a rubber.

2. Description of the Related Art

In recent years, the LCD device has been extensively used as a high-resolution display device. The LCD device comprises a transparent substrate on which switching elements such as Thin-Film Transistors (TFTs) are formed (which will be termed the “TFT substrate” below), another transparent substrate on which a color filter and a black matrix are formed (which will be termed the “color filter substrate” below), and a liquid crystal layer sandwiched between the TFT substrate and the color filter substrate. An electric field is applied across the pixel electrodes formed on the TFT substrate and the opposite (or common) electrode formed on the color filter substrate, or across the pixel electrodes and the opposite (or common) electrode all of which are formed on the TFT substrate, thereby changing the alignment direction of the liquid crystal molecules in the liquid crystal layer. Thus, the amount of the transmitted light in each pixel from a backlight is controlled to display desired images.

On the TFT or color filter substrate describe above, a variety of patterns are formed. For example, high-definition patterns whose line widths are relatively small (e.g., wiring lines and electrodes), relatively large patterns whose line widths are relatively large (e.g., a color filter), and full-surface patterns that cover the whole surface of the substrate (e.g., an insulating film) are formed on the TFT or color filter substrate. Conventionally, the photolithography method has been used to form these patterns. However, in recent years, to lower the fabrication cost of the LCD device furthermore, the use of a printing method has been researched and proposed as the substitute technique for the photolithography method that necessitates complicated processes and costly fabrication apparatuses.

For example, the Patent Document 1 (the Japanese Non-Examiner Patent Publication No. 11-198337) issued in 1999 discloses a printing apparatus using a flat bed, which is shown in FIG. 1.

With the prior-art printing apparatus shown in FIG. 1 a cylindrical blanket 102 whose surface has been subject to an ink-repellent process (e.g., a silicone blanket) is provided for a cylindrical transfer system 101. In the printing operation, first, a flat printing plate 103 having a flat surf ace on which a desired printing patter was formed is fixed on the said apparatus. Next, a blanket 102 having a surface on which an ink 104 was coated is brought into contact with the surface of the printing plate 103 and rolled along the printing plate 103. Then, unnecessary part of the ink is transferred to the raised part of the printing plate 103 and as a result, a desired ink pattern is formed on the blanket 102. Subsequently, the blanket 102 on which the desired ink pattern has been formed is brought into contact with a flat substrate 105 fixed on the said printing apparatus and rolled along the substrate 105. In this way, the ink pattern placed on the blanket 102 is transferred to the substrate 105. (See FIG. 1 and paragraphs 0009 to 0010 of the Patent Document 1.)

In the Patent Document 1, it is said that the formation of high-definition patterns equivalent to those obtained the photolithography method is possible with the said printing apparatus.

The Patent Document 2 (the Japanese Non-Examiner Patent Publication No. 5-169625) issued in 1993 discloses another printing apparatus that solves the problem of swelling of the blanket by prolonging the drying time of the blanket, which is shown in FIG. 2.

With the prior-art printing apparatus shown in FIG. 2, two blankets 112 and 113 are mounted to extend along the periphery of a cylindrical transfer system 111 in advance. The blanket 112 is used in the first printing operation and the blanket 113 is used in the second printing operation. Thus, it is unnecessary to use the same blanket 112 or 113 continuously, and an unused one of the blankets 112 and 113 can be cleaned sufficiently during its waiting time. According to the Patent Document 2, swelling of the blankets 112 and 113 is prevented for this reason, and as a result, the printing quality is improved. (See Abstract, FIG. 1 and claim 1 of the Patent Document 2.)

The Patent Document 3 (the Japanese Non-Examiner Patent Publication No. 6-64135) issued in 1994 discloses still another printing apparatus that reduces the height (or the diameter) of a transfer system, where each of a blanket and a printing plate is in the form of endless belt. This apparatus is shown in FIG. 3.

With the prior-art printing apparatus shown in FIG. 3, a transfer system 121 comprises a blanket carrier 122 having an endless belt-like form and a printing plate carrier 123 having a similar endless belt-like form. According to the Patent Document 3, a multiple printing operation using different printing plates or a multi-colored printing operation can be realized during one printing cycle without increasing the diameter of the transfer system 121 by simultaneously mounting a plurality of blankets and a plurality of printing plates. Moreover, the fabrication cost of the said printing apparatus can be suppressed (See Abstract and paragraphs 0006 to 0007 of the Patent Document 3.)

The Patent Document 4 (the Japanese Non-Examiner Patent Publication No. 6-91852) issued in 1994 discloses a further printing apparatus that corrects the relative positional displacement between a printing plate and a substrate, improving the positional accuracy. This apparatus is shown in FIG. 4.

With the prior-art printing apparatus shown in FIG. 4, a camera 132 is mounted in a transfer system 131. The transfer system 131 is structured in such a way that marks (not shown) formed on a printing plate 134 and marks 135 formed on a substrate 133 are read into the camera 132. After the marks on the printing plate 134 are read into the camera 132, the marks 135 on the substrate 133 are read into the camera 132 and compared with those of the 134, thereby detecting a relative positional displacement between the printing plate 134 and the substrate 133. In response to the positional displacement thus detected, the printing plate 134 or the substrate 133 is relatively moved for positional adjustment. Thus, the printing plate 134 and the substrate 133 are placed at the relatively same position with respect to the transfer system 131. According to the Patent Document 4, an automatic positioning operation for the printing plate 134 and the substrate 133 can be realized with high accuracy in this way. In addition, the reference numeral 136 denotes a cylindrical blanket mounted in the transfer system 131. (See Abstract and FIG. 1 of the Patent Document 4.)

However, the above-described prior-art printing apparatuses have the problems explained below.

With the prior-art printing apparatus of FIG. 1, disclosed in the Patent Document 1, the blanket 102 is likely to absorb the solvent of the ink 104 to result in swelling during continuous printing and therefore, the dimensions among the structural elements of the ink pattern on the blanket 102 tend to deviate from their initial values. As a result, a problem that the reproducibility of the said ink pattern degrades will arise. Moreover, since the ink pattern, which will be transferred to the flat substrate 105, is formed on the cylindrical blanket 102, sufficient alignment is unable to be performed prior to the transfer operations. Accordingly, there is another problem that the positional accuracy of the ink pattern is insufficient to fabricate the TFT substrate or the like.

With the prior-art printing apparatus of FIG. 2, disclosed in the Patent Document 2, the length of the circumference of the transfer system 111 needs to be much longer than the length of the substrate in order to mount the blankets 112 and 113 on the transfer system 111. To prolong the circumference of the transfer system 111, the diameter of the cylindrical transfer system 111 needs to be increased. Accordingly, a problem of the expensive fabrication cost of the said printing apparatus occurs. In addition, because of the diameter increase of the transfer system 111, the peeling angle at the transfer of the ink pattern from the blanket 112 or 113 to the substrate is decreased. As a result, there is another problem that the ink pattern is unable to be transferred as desired.

With the prior-art printing apparatus shown in FIG. 3, disclosed in the Patent Document 3, the transfer of the ink pattern from the blanket carrier 122 to the printing plate carrier 123 is performed at the cylindrical parts of the carriers 122 and 123. Therefore, the accurate alignment of the both carriers 122 and 123 is unable to be carried out before the transfer operation. For this reason, similar to the prior-art printing apparatus shown in FIG. 1, a problem that the positional accuracy of the ink pattern is insufficient to fabricate the TFT substrate or the like occurs.

With the prior-art printing apparatus shown in FIG. 4, disclosed in the Patent Document 4, since the cylindrical blanket 136 is used, direct alignment between the ink pattern placed on the blanket 136 and the substrate 134 is unable to be carried out. Therefore, a problem that the positional accuracy of the ink pattern is insufficient arises. Moreover, if the applied pressure between the printing plate 134 and the blanket 136 and that between the substrate 133 and the blanket 136 in their contact states are different from each other, the length of the circumference of the cylindrical blanket 136 contacted with the printing plate 134 will be different from that of the blanket 136 contacted with the substrate 133. For this reason, there arises another problem that the ink pattern is not printed at the predetermined position on the substrate 133 due to the circumference length difference even if the relative alignment operation between the printing plate 134 and the substrate 133 is performed.

### SUMMARY OF THE INVENTION

The present invention was created to solve the above-described problems in the above-described prior-art printing apparatuses.

An object of the present invention is to provide a printing method and a printing apparatus that make it possible to realize good reproducibility of an ink pattern and that facilitate both the alignment operation between a printing plate and a blanket and the alignment operation between a blanket and a substrate, thereby realizing the printing (i.e., ink pattern transfer) with positional accuracy as high as the TFT substrate or the like can be fabricated.

Another object of the present invention is to provide a printing method and a printing apparatus that enable the continuous printing with good reproducibility of an ink pattern in high positional accuracy.

Still another object of the present invention is to provide a printing method and a printing apparatus that realize the printing operation with good reproducibility of an ink pattern in high positional accuracy without tact time degradation in fabrication.

A further object of the present invention is to provide a LCD device that can be fabricated at a lower cost by forming a variety of patterns on a substrate by printing.

The above objects together with others not specifically mentioned will become clear to those skilled in the art from the following description.

According to the first aspect of the invention, a printing method for printing an ink pattern, which is formed on a blanket using a printing plate, to a substrate is provided.

This method comprises the steps of:

providing a flat portion of the blanket:

contacting the flat portion of the blanket an ink pattern formed in a flat portion of the printing plate in their opposing state and detaching the flat portions from each other, thereby transferring the ink pattern to the flat portion of the blanket; and

contacting the flat portion of the blanket with the transferred ink pattern a flat portion of the substrate in their opposing state and detaching the flat portions from each other, thereby transferring the ink pattern to the substrate from the blanket.

With the printing method according to the first aspect of the invention, the blanket is contacted the printing plate on their flat portions in their opposing state and then, they are detached from each other, thereby transferring the ink pattern to the flat portion of the blanket from the printing plate. In this way, the blanket and the printing plate are contacted each other on their flat portions before the transfer of the ink pattern to the blanket and therefore, the alignment operation between the flat portions of the blanket and the printing plate can be carried out in their opposing state. For this reason, the alignment operation between the blanket and the printing plate can be easily performed and at the same time, highly accurate alignment (positional adjustment) therebetween can be carried out in comparison with the combination of the cylindrical blanket and the flat printing plate.

Moreover, the flat portion of the blanket on which the ink pattern has been formed, and the flat portion of the substrate are contacted each other in their opposing state and detached from each other, thereby transferring the ink pattern to the substrate from the blanket. In this way, the blanket and the substrate are contacted each other on their flat portions before the transfer of the ink pattern from the blanket to the substrate and therefore, alignment between the blanket and the substrate can be carried out in their opposing state. For this reason, the alignment operation between the blanket and the substrate can be easily performed and at the same time, highly accurate alignment (positional adjustment) therebetween can be carried out in comparison with the combination of the cylindrical blanket and the flat substrate.

Further, since the flat portion of the blanket and that of the substrate are contacted each other in their opposing state and detached from each other to transfer the ink pattern to the substrate from the blanket, good transferability of the ink pattern to the substrate is obtained. In other words, good reproducibility of the ink pattern is realized.

Accordingly, good reproducibility of the ink pattern is obtainable and both of the alignment operation between the printing plate and the blanket and that between the blanket and the substrate are easily carried out. This means that the ink pattern transfer (i.e., the printing) can be performed with positional accuracy as high as the TFT substrate or the like can be fabricated.

In a preferred embodiment of the printing method according to the first aspect of the invention, before the flat portions of the blanket and the printing plate are contacted each other in their opposing state, at least one of the flat portions of the blanket and the printing plate is deformed or moved and thereafter, the flat portions are aligned. In this embodiment, the alignment operation between the flat portion of the blanket and that of the printing plate can be performed with higher accuracy before the blanket and the printing plate are contacted.

In subsequent preferred embodiments of the printing method according to the first aspect of the invention, the flat portions of the blanket and the substrate are the same as the aforementioned embodiment.

In another preferred embodiment of the printing method according to the first aspect of the invention, three or more alignment marks are formed on each of the blanket, the printing plate, and the substrate, and the flat portions of them are aligned with each other using the alignment marks. In this embodiment, the blanket may be deformed by application of an external force when the flat portions are aligned. If so, the alignment operation is performed with higher accuracy. The alignment marks maybe formed by utilizing the ink pattern or formed separately from the ink pattern. The alignment marks may be used in both the blanket-printing plate alignment and the blanket-substrate alignment.

In a still further preferred embodiment of the printing method according to the first aspect of the invention, when detaching the flat portions of the blanket, the printing plate, and the substrate from each other, an angle between the flat portions thereof is changed by deforming the blanket, thereby generating a desired detachment angle. In this embodiment, the desired detachment angle is easily provided and therefore, the ink pattern can be formed on the blanket more smoothly.

In a still further preferred embodiment of the printing method according to the first aspect of the invention, the blanket is an endless belt-shaped and is put between two rotatable rollers, wherein the flat portion of the blanket is formed between the rollers. In this embodiment, because the unused surface of the blanket can be dried during the printing operation using the flat portion thereof, the printing operation can be continuously with good reproducibility of the ink pattern and high positional accuracy without extending tact time in fabrication. Moreover, since the swelling of the blanket is minimized, the life of the blanket is prolonged and the exchange frequency of the blanket is decreased.

In a still further preferred embodiment of the printing method according to the first aspect of the invention, an unused surface of the blanket is dried with a blanket drying system. In this embodiment, the unused surface of the blanket can be dried without extending the tact time in fabrication. Therefore, the swelling of the blanket can be minimized and at the same time, the surface condition of the blanket can be kept approximately the same at all times. This means that the reproducibility of the ink pattern can be enhanced.

In a still further preferred embodiment of the printing method according to the first aspect of the invention, a flexible substrate is used as the substrate. The flexible substrate is transportable between a pair of substrate support rollers and comprises a flat portion between the pair of substrate support rollers. The flat portion of the blanket is contacted with the flat portion of the flexible substrate, thereby transferring the ink pattern on the blanket to the flexible substrate. In this embodiment, the ink pattern can be printed on the flexible substrate in its continuous form without dividing the substrate.

In a still further preferred embodiment of the printing method according to the first aspect of the invention, the ink pattern is transferred from the printing plate to the substrate by way of the blanket using a plurality of the printing plates simultaneously or while exchanging a plurality of the printing plates. In this embodiment, the ink pattern can be transferred (i.e., printed) continuously with good reproducibility of the ink pattern and high positional accuracy.

According to the second aspect of the invention, a printing apparatus for printing an ink pattern, which is formed on a blanket using a printing plate, to a substrate is provided.

This apparatus comprises:

a transfer system comprising a blanket with a flat portion;

an ink pattern formation system for forming an ink pattern on the flat portion of the blanket in cooperation with the transfer system by contacting the flat portion of the blanket a flat portion of the printing plate in their opposing state and detaching the flat portions from each other; and

an ink pattern transfer system for transferring the ink pattern to the substrate from the blanket in cooperation with the transfer system by contacting the flat portion of the blanket a flat portion of the substrate in their opposing state and detaching the flat portions from each other.

With the printing apparatus according to the second aspect of the invention, the transfer system comprises the blanket with the flat portion. Moreover, in cooperation with the transfer system, the ink pattern formation system forms the ink pattern on the flat portion of the blanket by contacting the flat portion of the blanket the flat portion of the printing plate in their opposing state and detaching the flat portions from each other. Subsequently, in cooperation with the transfer system, the ink pattern transfer system transfers the ink pattern to the substrate from the blanket by contacting the flat portion of the blanket a flat portion of the substrate in their opposing state and detaching the flat portions from each other. Therefore, the printing method according to the first aspect of the invention can be carried out.

Accordingly, good reproducibility of the ink pattern is obtainable and both of the alignment operation between the printing plate and the blanket and that between the blanket and the substrate are easily carried out. This means that the ink pattern transfer (i.e., the printing) can be performed with positional accuracy as high as the TFT substrate or the like can be fabricated.

In a preferred embodiment of the printing apparatus according to the second aspect of the invention, a position correction system is additionally provided. Before the flat portions of the blanket and the printing plate are contacted each other in their opposing state, at least one of the flat portions of the blanket and the printing plate is deformed or moved and thereafter, the flat portions are aligned by the position correction system.

In another preferred embodiment of the printing apparatus according to the second aspect of the invention, a position correction system is additionally provided. Before the flat portions of the blanket and the substrate are contacted each other in their opposing state, at least one of the flat portions of the blanket and the substrate is deformed or moved and thereafter, the flat portions are aligned by the position correction system.

In still another preferred embodiment of the printing apparatus according to the second aspect of the invention, three or more alignment marks are formed on each of the blanket and the printing plate, and the flat portion of the blanket and the flat portion of the printing plate are aligned using the alignment marks. In this embodiment, the blanket may be deformed by application of an external force when the flat portions are aligned. If so, the alignment operation is performed with higher accuracy. The alignment marks may be formed by utilizing the ink pattern or formed separately from the ink pattern. The alignment marks may be used in both the blanket-printing plate alignment and the blanket-substrate alignment.

In a further preferred embodiment of the printing apparatus according to the second aspect of the invention, three or more alignment marks are formed on each of the blanket and the substrate, and the same operation between them is carried out.

In a still further preferred embodiment of the printing apparatus according to the second aspect of the invention, a printing plate stage on which the printing plate is placed and a substrate stage on which the substrate is placed are additionally provided. When the ink pattern is formed on the flat portion of the blanket, the blanket or the printing plate stage is moved to generate a state where the flat portion of the blanket and the flat portion of the printing plate are opposed. When the ink pattern is transferred to the substrate from the blanket, the blanket or the substrate stage is moved to generate a state where the flat portion of the blanket and the flat portion of the substrate are opposed. In this embodiment, the said printing apparatus can be reduced in size and the space can be saved.

In a still further preferred embodiment of the printing apparatus according to the second aspect of the invention, a blanket deformation mechanism is additionally provided. When detaching the flat portion of the blanket and the flat portion of the printing plate from each other, an angle between the flat portion of the blanket and the flat portion of the printing plate is changed by deforming the blanket using the blanket deformation mechanism, thereby generating a desired detachment angle.

In a still further preferred embodiment of the printing apparatus according to the second aspect of the invention, a blanket deformation mechanism is additionally provided. When detaching the flat portion of the blanket and the flat portion of the substrate from each other, an angle between the flat portion of the blanket and the flat portion of the substrate is changed by deforming the blanket using the blanket deformation mechanism.

In a still further preferred embodiment of the printing apparatus according to the second aspect of the invention, the blanket is an endless belt-shaped and put between two rotatable rollers, where the flat portion of the blanket is formed between the rollers.

In this embodiment, each of the rollers may be formed by a plurality of sub-rollers. In this case, the position correction of the blanket can be performed easily by displacing the respective sub-rollers. It is preferred that the transfer system comprises at least one blanket roller. In this case, the area or size of the blanket can be expanded furthermore and therefore, the number of the unused surfaces of the blanket and/or the unused area or size of the blanket can be increased.

In a still further preferred embodiment of the printing apparatus according to the second aspect of the invention, a blanket drying system is additionally provided for drying the unused flat portion of the blanket.

In a still further preferred embodiment of the printing apparatus according to the second aspect of the invention, a pair of substrate support rollers for transporting the flexible substrate to have a predetermined tension is additionally provided, wherein the flat portion of the substrate is formed between the pair of substrate support rollers. In this embodiment, the ink pattern can be printed on the flexible substrate in its continuous form without dividing the substrate.

In a still further preferred embodiment of the printing apparatus according to the second aspect of the invention, the ink pattern is transferred from the printing plate to the substrate by way of the blanket using a plurality of the printing plates simultaneously or while exchanging the printing plate for another printing plate with a printing plate exchanging system. In this embodiment, the ink pattern can be transferred (i.e., printed) continuously with good reproducibility of the ink pattern and high positional accuracy.

According to the third aspect of the invention, a LCD device is provided, which comprises:

a pair of transparent substrates; and

a liquid crystal layer sandwiched by the pair of transparent substrates;

wherein at least one of the pair of transparent substrates comprises an ink pattern printed by the printing method according to the first aspect of the invention.

With the LCD device according to the third aspect of the invention, since at least one of the pair of transparent substrates comprises the ink pattern printed by the printing method according to the first aspect of the invention, the said ink pattern is printed with good reproducibility and positional accuracy as high as the TFT substrate or the like can be fabricated. Accordingly, by forming a variety of patterns on the substrate or substrates by printing, the fabrication cost of the LCD device can be lowered.

### BRIEF DESCRIPTION OF THE DRAWINGS

In order that the present invention may be readily carried into effect, it will now be described with reference to the accompanying drawings.

FIG. 1 is an explanatory cross-sectional view showing the schematic structure of a first example of the prior-art printing apparatuses.

FIG. 2 is an explanatory cross-sectional view showing the schematic structure of a second example of the prior-art printing apparatuses.

FIG. 3 is an explanatory cross-sectional view showing the schematic structure of a third example of the prior-art printing apparatuses.

FIG. 4 is an explanatory cross-sectional view showing the schematic structure of a fourth example of the prior-art printing apparatuses.

FIG. 5 is a cross-sectional view showing the schematic structure of the transfer system of a printing apparatus used for a printing method according to a first embodiment of the invention.

FIG. 6 is a perspective view showing the entire schematic structure of the printing apparatus according to the first embodiment of the invention.

FIG. 7 is a side view showing the entire schematic structure of the printing apparatus according to the first embodiment of the invention.

FIG. 8 is a side view of the printing plate stage and the substrate stage incorporated into the printing apparatus according to the first embodiment of the invention.

FIG. 9 is a plan view of the printing plate stage and the substrate stage incorporated into the printing apparatus according to the first embodiment of the invention.

FIG. 10 is a front view of the transfer system incorporated into the printing apparatus according to the first embodiment of the invention, which is seen from the printing direction.

FIG. 11 is a side view of the position correction system provided in the transfer system incorporated into the printing apparatus according to the first embodiment of the invention.

FIG. 12 is a front view of the position correction system provided in the transfer system incorporated into the printing apparatus according to the first embodiment of the invention.

FIGS. 13A to 13D are explanatory side views showing the step of transferring the ink pattern to the blanket from the printing plate in the printing method according to the first embodiment of the invention, respectively.

FIGS. 14A to 14C are explanatory side views showing the step of transferring the ink pattern to the substrate from the blanket in the printing method according to the first embodiment of the invention, respectively.

FIGS. 15A and 15B are explanatory side views showing the step of positioning between the printing plate and the blanket in the printing method according to the first embodiment of the invention, respectively.

FIG. 16 is an explanatory side view showing the step of positioning between the substrate and the blanket in the printing method according to the first embodiment of the invention.

FIG. 17 is a plan view showing an image of the alignment marks read into the alignment camera in the positioning step in the printing method according to the first embodiment of the invention.

FIG. 18A is a plan view of the substrate stage incorporated into the printing apparatus according to the first embodiment of the invention.

FIG. 18B is in bottom view of the transfer system of the printing apparatus according to the first embodiment of the invention.

FIG. 19 is an explanatory side view showing the schematic structure of the transfer system incorporated into a printing apparatus according to a second embodiment of the invention.

FIG. 20 is an explanatory side view showing the schematic structure of the transfer system of the printing apparatus according to a second embodiment of the invention, where a blanket drying system is added.

FIG. 21 is an explanatory plan view showing the schematic structure of a printing apparatus according to a third embodiment of the invention.

FIG. 22 is an explanatory side view showing the schematic structure of a printing apparatus according to a fourth embodiment of the invention.

FIG. 23A is an explanatory partial cross-sectional view showing the schematic structure of the transfer system incorporated into a printing apparatus according to a fifth embodiment of the invention.

FIG. 23B is an explanatory partial cross-sectional view showing a deformed state of the blanket of the transfer system of the printing apparatus according to the fifth embodiment of the invention.

FIGS. 24A to 24C are explanatory partial cross-sectional views of the vicinity of the blanket and the substrate stage, respectively, showing the printing step of a printing apparatus according to a sixth embodiment of the invention, respectively.

FIG. 25 is an explanatory partial cross-sectional view of the vicinity of the blanket and the printing plate stage, showing a printing apparatus according to a seventh embodiment of the invention.

FIG. 26 is an explanatory partial plan view of the transfer system incorporated into a printing apparatus according to an eighth embodiment of the invention.

FIG. 27A is a schematic plan view showing the structure of a LCD device, in which both of the TFT substrate and the color filter substrate are fabricated by the printing method according to the first embodiment of the invention.

FIG. 27B is a schematic enlarged cross-sectional view of the region A in the LCD device of FIG. 27A.

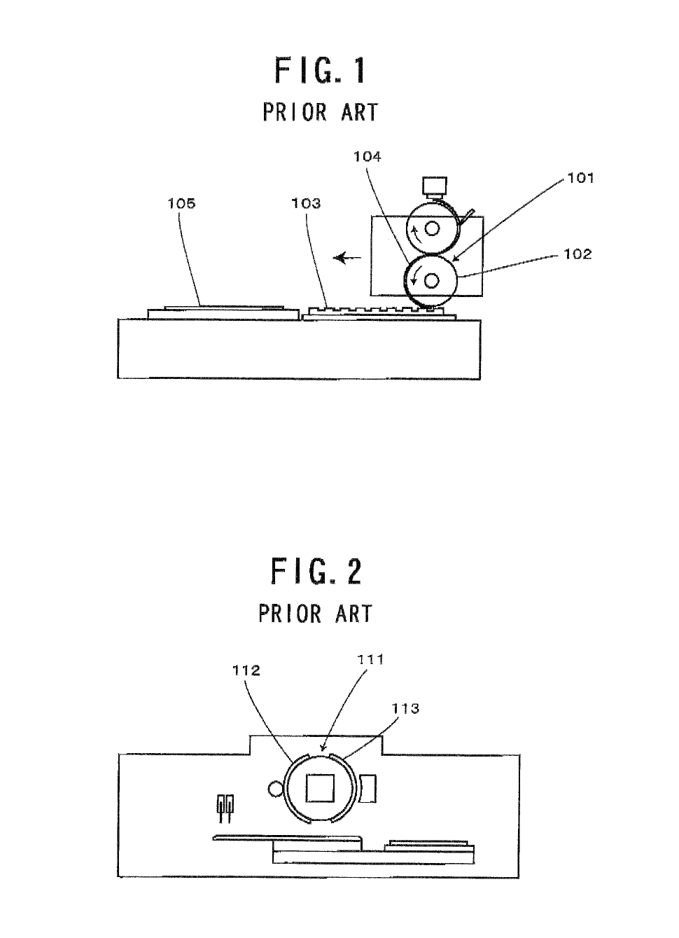

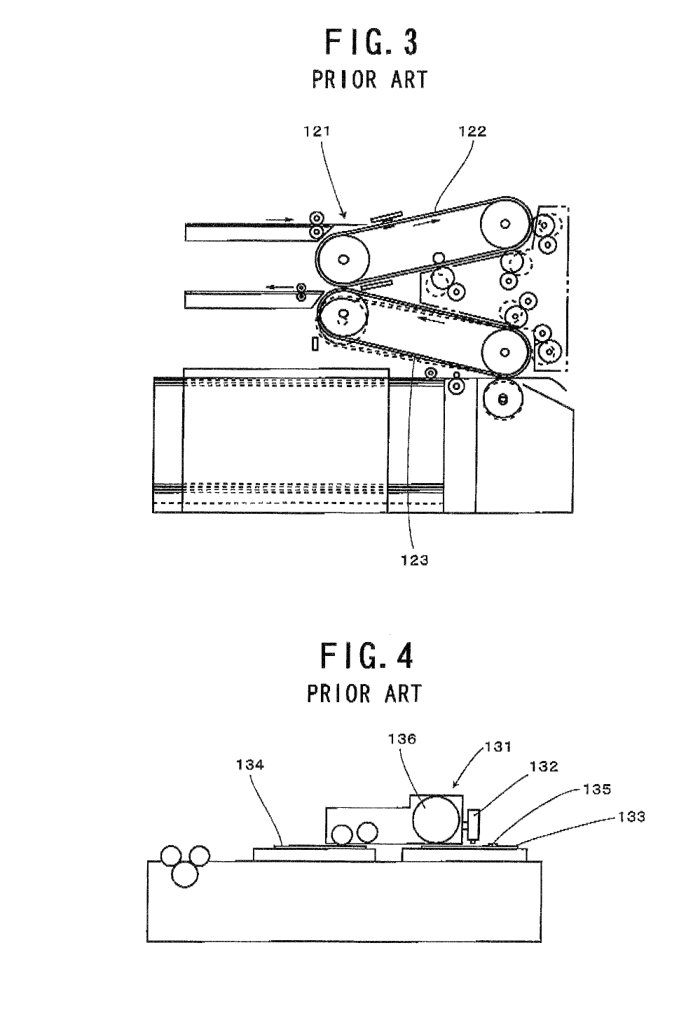

### DETAILED DESCRIPTION OF THE PREFERRED EMBODIMENTS

Preferred embodiments of the present invention will be described in detail below while referring to the drawings attached.

### First Embodiment

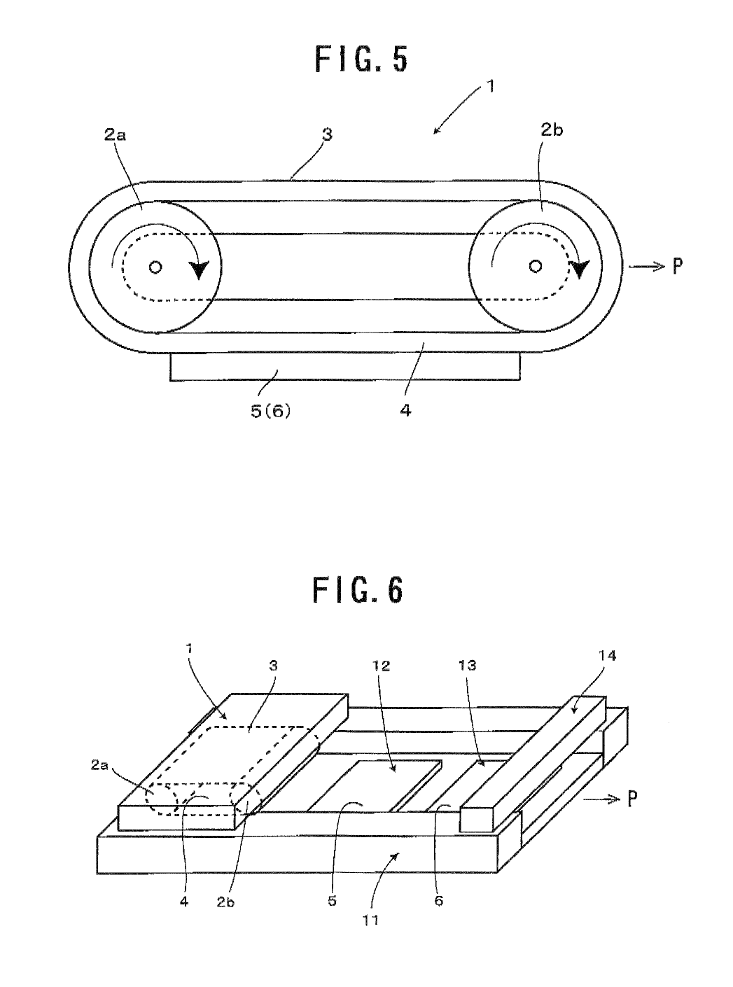

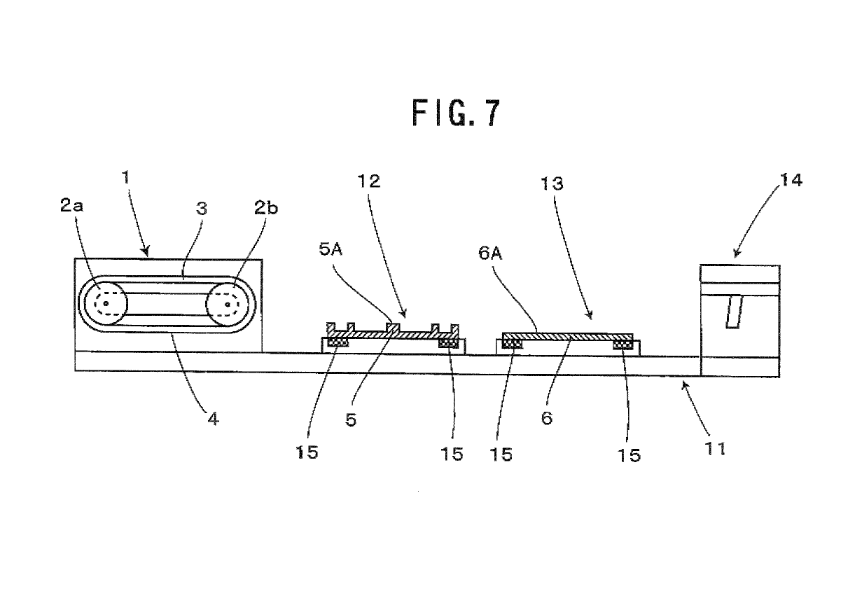

A transfer system or mechanism 1 of a printing apparatus used in a printing method according to a first embodiment of the invention is shown in FIGS. 5 to 7. FIG. 5 shows the structure of the transfer system 1 and FIGS. 6 and 7 show the structure of the printing apparatus.

As shown in FIG. 5, a transfer system 1 comprises a pair of printing rollers 2a and 2b, and a blanket 3 placed to surround the rollers 2a and 2b. The side shape of the transfer system 1 is approximately elliptic. Concretely speaking, the two cylindrical printing rollers 2a and 2b are disposed apart from each other at a predetermined distance in such away as to be approximately parallel to the printing direction P. The endless belt-shaped blanket 3 is put around the rollers 2a and 2b. A lower one of the two horizontally extending portions of the blanket 3 between the rollers 2a and 2b forms a flat portion 4 to be used for the formation and transfer of an ink pattern.

Here, the diameters of the two rollers 2a and 2b are equal; however, they need not be equal. The diameters of the rollers 2a and 2b may be different if the flat portion 4 is formed between the rollers 2a and 2b.

In the printing operation, the rollers 2a and 2b are rotated along the same direction by a driving mechanism (not shown) provided in the transfer system 1. According to the rotation of the rollers 2a and 2b, the blanket 3 is moved around the rollers 2a and 2b. If a printing plate 5 or a substrate 6 held at a predetermined position is engaged with the flat portion 4 of the blanket 3, the transfer system 1 itself including the rollers 2a and 2b is translated along the printing direction P subsequent to the rotary movement of the blanket 3.

When a desired ink pattern is formed on the blanket 3 using the flat printing plate 5, the flat portion 4 of the blanket 3 and the surface (i.e., the flat portion) of the printing plate 5 are brought into contact with each other, as shown in FIG. 5. At this time, the flat portion 4 of the blanket 3 and the printing plate 5 are in contact with each other on their flat surfaces, which means that they are in plane contact. Thereafter, the printing rollers 2a and 2b are rotated in the same direction to thereby move the transfer system 1 along the printing direction P. As a result, a desired ink pattern is formed on the flat portion 4 of the blanket 3.

Similarly, when the ink pattern formed on the blanket 3 is transferred to the flat substrate 6 also, the flat portion 4 of the blanket 3 and the surface (i.e., the flat portion) of the substrate 6 are brought into contact with each other. At this time, the flat portion 4 of the blanket 3 and the substrate 6 are in contact with each other on their flat surfaces. Thereafter, the printing rollers 2a and 2b are rotated in the same direction to thereby move the transfer system 1 along the printing direction P. As a result, the ink pattern formed on the blanket 3 is transferred onto the surface of the substrate 6.

In addition, at least one other printing roller may be added to the printing rollers 2a and 2b, where the endless belt-shaped blanket 3 is put among the three or more printing rollers. A blanket drying system or mechanism may be additionally provided for drying the unused surface of the blanket 3.

Next, the structure of the printing apparatus according to the first embodiment of the invention, which includes the above-described transfer system 1, will be explained below with reference to FIGS. 6 and 7.

This printing apparatus comprises in its body 11 the above-described transfer system 1, a printing plate stage 12, a substrate stage 13, and a coating system or mechanism 14. These are arranged along the printing direction P in this order in FIG. 6. The transfer system 1 and the coating system 14 are movable along the body 11 in the printing direction P. In the said first embodiment, the printing plate stage 12 and the substrate stage 13 are not movable.

On the printing plate stage 12, the printing plate 5 is fixed for forming the desired ink pattern. The surface of the printing plate 5 is the flat portion 5A, on which a pattern section (which includes the protrusions or depression for the ink pattern) is formed. On the substrate stage 13, the substrate 6 on which the desired ink pattern is formed is fixed. The surface of the substrate 6 is the flat portion 6A. The reference numeral 15 in FIG. 7 denotes an alignment camera.

The number of the printing plate 5 fixed on the printing plate stage 12 may be plural. It is sufficient that the printing plate 5 is a printing plate to be used for offset printing. Concretely, any printing plate designed for planographic, intaglio, relief, or flexographic printing may be used for the printing plate 5.

As the coating system 14, any type of coating system or mechanism may be used if it is able to form an ink film having a uniform thickness by coating. Concretely, the squeegee, roll coater, or slit coater type of coating system may be used for this purpose.

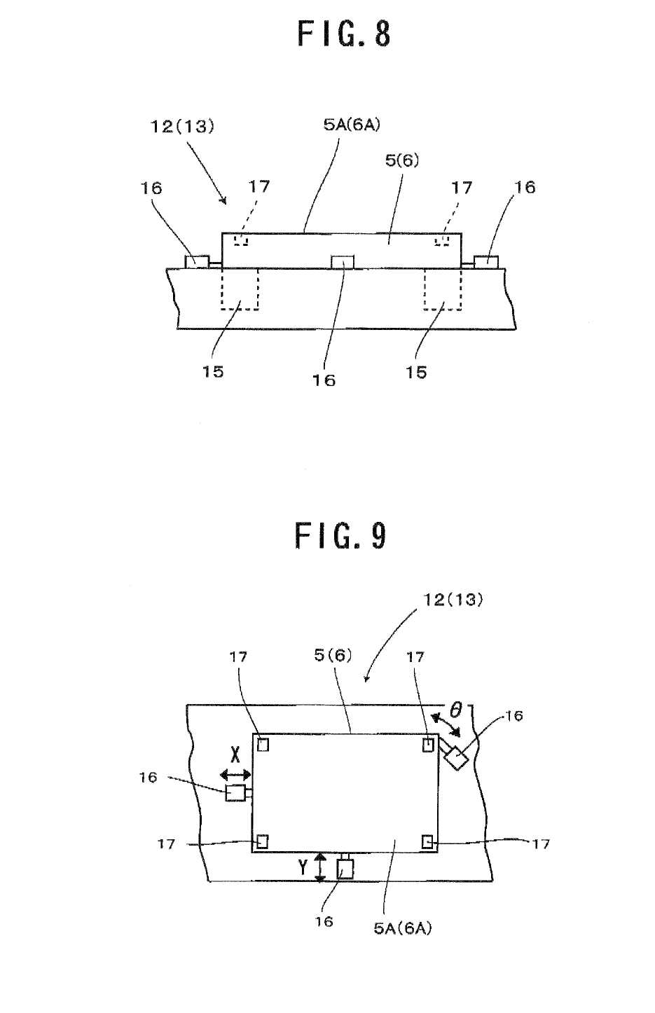

The detailed structures of the printing plate stage 12 and the substrate stage 13 are shown in FIGS. 8 and 9, respectively. FIG. 8 is a side view of the stages 12 and 13 and FIG. 9 is a plan view thereof.

A plurality of alignment cameras 15 and a plurality of driving systems or mechanisms 16 are provided in each of the printing plate stage 12 and the substrate stage 13. The driving systems 16 provided in the printing plate stage 12 are used to move the printing plate stage 12. The driving systems 16 provided in the substrate stage 13 are used to move the substrate stage 13. The cameras 15 provided in the printing plate stage 12 can read alignment marks 17 formed on the printing plate 5 and those formed on the blanket 3 simultaneously. The cameras 15 provided in the substrate stage 13 can read the marks 17 formed on the substrate 6 and those formed on the blanket 3 simultaneously.

Each of the alignment marks 17 formed on the printing plate 5 and those formed on the substrate 6 is constituted by transparent parts and opaque parts in order to be read by a corresponding one of the alignment cameras 15. Therefore, the marks 17 formed on the printing plate 5 can be read by the cameras 15 mounted below the printing plate stage 12, and those on the substrate 6 can be read by the cameras 15 mounted below the substrate stage 13.

The alignment operation between the flat portion 4 of the blanket 3 and the surface (i.e., the flat portion 5A) of the printing plate 5 or the surface (i.e., the flat portion 6A) of the substrate 6 is carried out in a plane. Therefore, the alignment marks 17 need to be arranged at three positions or more on each of the flat portion 5A of the printing plate 5 and the flat portion 6A of the substrate 6. In response, the marks 17 are arranged at three positions or more on the flat portion 4 of the blanket 3 corresponding to the marks 17 on the flat portion 5A or the flat portion 6A. The cameras 15 are disposed in such a way as to overlap accurately with the corresponding marks 17.

Specifically, in the said first embodiment, the four alignment marks 17 in total are arranged at the respective corners (four positions in total) of each of the rectangular printing plate 5 and the rectangular substrate 6. Moreover, the four alignment marks 17 in total are arranged at the respective corners (four positions in total) of the flat portion 4 of the blanket 3 in such a way as to overlap with the corresponding marks 17 on the printing plate 5 and the rectangular substrate 6. The four alignment cameras 15 in total are mounted on each of the printing plate stage 12 and the substrate stage 13.

Each alignment mark 17 may have any plan shape. A part of the ink pattern to be formed may be used as the alignment mark or marks 17.

Each of the printing plate stage 12 and the substrate stage 13 comprises the driving systems 16, each of which is constituted by a known actuator or the like. In the said first embodiment, since the printing plate 5 and the substrate 6 are movable along the X, Y, and θ directions, as shown in FIG. 9, the three driving systems 16 in total are provided for the movements along these three directions in each of the stages 12 and 13. The X direction is a direction along which the transfer system 1 is moved, i.e., the printing direction P. The Y direction is a direction perpendicular to the printing direction P, in other words, the widthwise direction of the transfer system 1 (i.e., the blanket 3). The θ direction is a rotary direction in the X-Y plane (i.e., the surface of the printing plate stage 12 or the substrate stage 13).

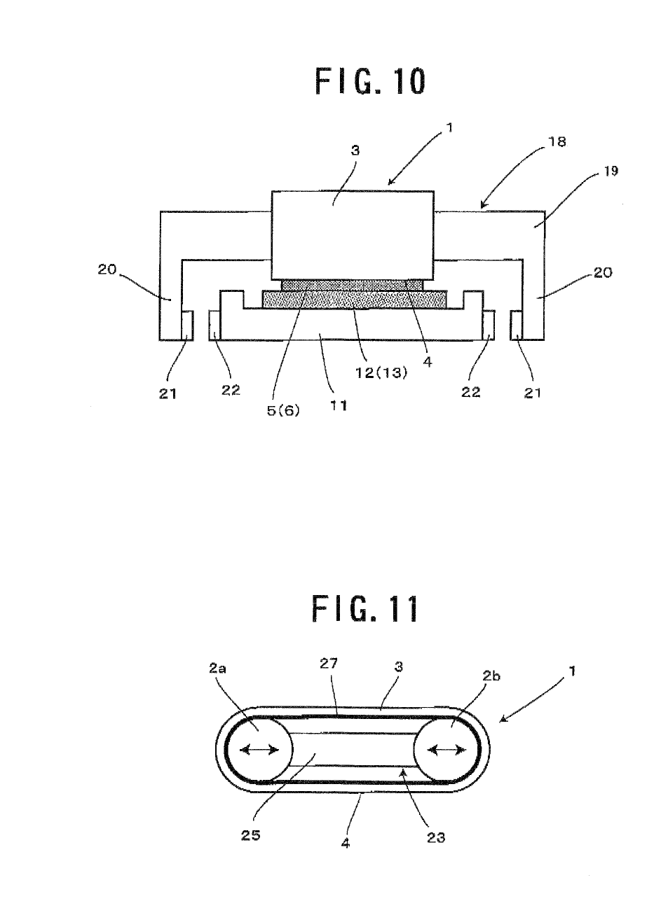

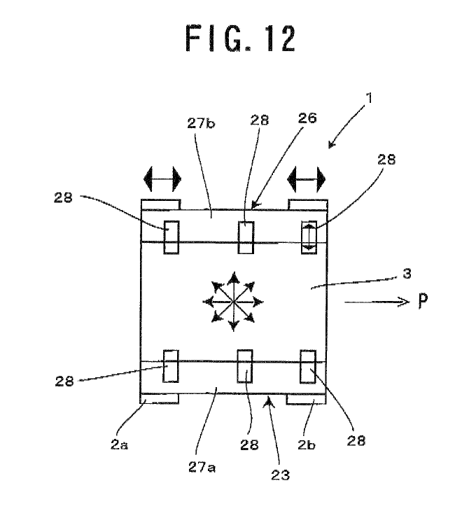

FIGS. 10 to 12 are schematic illustrations showing the detailed structure of the transfer system 1. FIG. 10 is a front view of the transfer system 1 seen from the printing direction P. FIG. 11 is a side view of a position correction system or mechanism 23 provided in the transfer system 1. FIG. 12 is a plan view of the position correction system 23.

As shown in FIG. 10, the transfer system 1 is structured in such a way as to be translated along the printing direction P over the printing plate 5 fixed on the printing plate stage 12 and the substrate 6 fixed on the stage 13. To keep the positional accuracies of the blanket 3 of the transfer system 1, the printing plate 5, and the substrate 6 within the range of ±2.0 μm, more preferably ±1.0 μm, the transfer system 1 is moved by a moving device or mechanism 18 driven by a linear motor.

Concretely speaking, the moving mechanism 18 for the transfer system 1 comprises a frame 19 whose shape is like a reversed U character. The frame 19, which supports the transfer system 1, is mounted in such a way as to stride over the body 11 and is translatable along the printing direction P (i.e., the body 11). Two movable electromagnets 21 of the linear motor are respectively fixed to the two arms 20 of the frame 19. Two immovable electromagnets 22 of the said linear motor are fixed to the body 11 at the corresponding positions to the movable electromagnets 21. For this reason, the transfer system 1 can be translated along the body 11 (i.e., the printing direction P) with the magnetic force generated by the electromagnets 21 and 22, and can be stopped at any desired position.

In the said first embodiment, the transfer system 1 is moved with respect to the body 11; however, the invention is not limited to this. Any structure may be used for this purpose if desired printing accuracy can be realized. For example, the transfer system 1 may be fixed while the printing plate stage 12 and the substrate stage 13 may be movable.

The position correction system 23 may be provided in the transfer system 1 for correcting the relative position of the blanket 3, as shown in FIGS. 11 and 12. FIG. 11 is a side view of the position correction system 23 and FIG. 12 shows a plan view thereof.

The position correction system 23 comprises a lengthwise position correcting system 25 for changing the interval between the printing rollers 2a and 2b, and a widthwise position correcting system 26 for adjusting the widthwise position of the blanket 3 with respect to the rollers 2a and 2b, and the width of the blanket 3 itself.

A tension along the printing direction P (i.e., the X direction) can be applied to the blanket 3 by changing the positions of the printing rollers 2a and 2b (i.e., the interval between the rollers 2a and 2b) using the lengthwise position correcting system 25. For example, if the interval between the rollers 2a and 2b is increased, the blanket 3 is extended accordingly. On the other hand, if the interval between the rollers 2a and 2b is decreased, the blanket 3 is shortened accordingly. In this way, by changing the interval between the rollers 2a and 2b using the lengthwise position correcting system 25, the relative position of the flat portion 4 of the blanket 3 along the printing direction P can be corrected. Since the blanket 3 usually has a two-layer structure of a rubber layer placed on the surface side and a cushion layer placed on the rear side, and has a predetermined elasticity, the blanket 3 can be extended and shortened in such a manner as above.

Moreover, the blanket 3 can be extended and shortened and/or the position of the blanket 3 can be shifted along the widthwise direction (i.e., the Y direction) thereof by applying external forces to the blanket 3 from its both sides. Therefore, the position correction of the blanket 3 along its widthwise direction perpendicular to the printing direction P can be corrected using the widthwise position correcting system 26.

The widthwise position correcting system 26 comprises two endless loop-shaped reference belts 27a and 27b put around the printing rollers 2a and 2b at the both sides of the blanket 3, and a plurality of driving devices 28 (each of which is constituted by an actuator or the like) that interconnect the reference belts 27a and 27b with the blanket 3, respectively, as shown in FIG. 12. Each of the driving devices 28 has a function of adjusting the distance between the reference belt 27a or 27b and the blanket 3. The driving devices 28 placed on each side of the blanket 3 are designed to conduct the same operation synchronously. Specifically, the driving devices 28 placed on the same side of the blanket 3 increase or decrease the distance between the reference belt 27a or 27b and the blanket 3 in unison according to the necessity. In this way, the widthwise position of the blanket 3 can be corrected. Since the driving devices 28 interconnect the reference belts 27a or 27b with the blanket 3, they are moved around the rollers 2a and 2b along with the reference belt 27a or 27b and the blanket 3 in response to the rotation of the rollers 2a and 2b.

The driving devices 28 are arranged at intervals along the longitudinal direction of the blanket 3 (i.e., the printing direction P) on each side thereof. In this case, the reference belts 27a and 27b need to be configured in such a way as not to be displaced with respect to the rollers 2a and 2b along the widthwise direction of the blanket 3, in other words, the reference belts 27a and 27b need to be positioned along the widthwise direction. Such the need may be realized in the following way.

For example, grooves or depressions (not shown) in which the reference belts 27a and 27b are fitted are formed adjacent to the respective ends of the blanket 3 at the both ends of the printing rollers 2a and 2b. The belts 27a and 27b are respectively fitted in the grooves or depressions of the rollers 2a and 2b. As a result, the positioning (i.e., the displacement prevention) of the belts 27a and 27b with respect to the rollers 2a and 2b along the widthwise direction of the blanket 3 can be performed.

As explained above, by providing the position correction system 23, the positions of the blanket 3 and the ink pattern formed thereon can be corrected along the printing direction P (i.e., the X direction) and the direction perpendicular thereto (i.e., the Y direction). For this reason, when the flat portion 4 of the blanket 3 and the flat portion 6A of the substrate 6, which have been contacted with each other, are detached, or when the flat portion 4 of the blanket 3 and the flat portion 5A of the printing plate 5, which have been contacted with each other, are detached, the blanket 3 can be deformed. Thus, desired detachment angles can be obtained in the above detachment operations utilizing the deformation of the blanket 3 and as a result, there is an advantage that the ink pattern 31 can be transferred more smoothly.

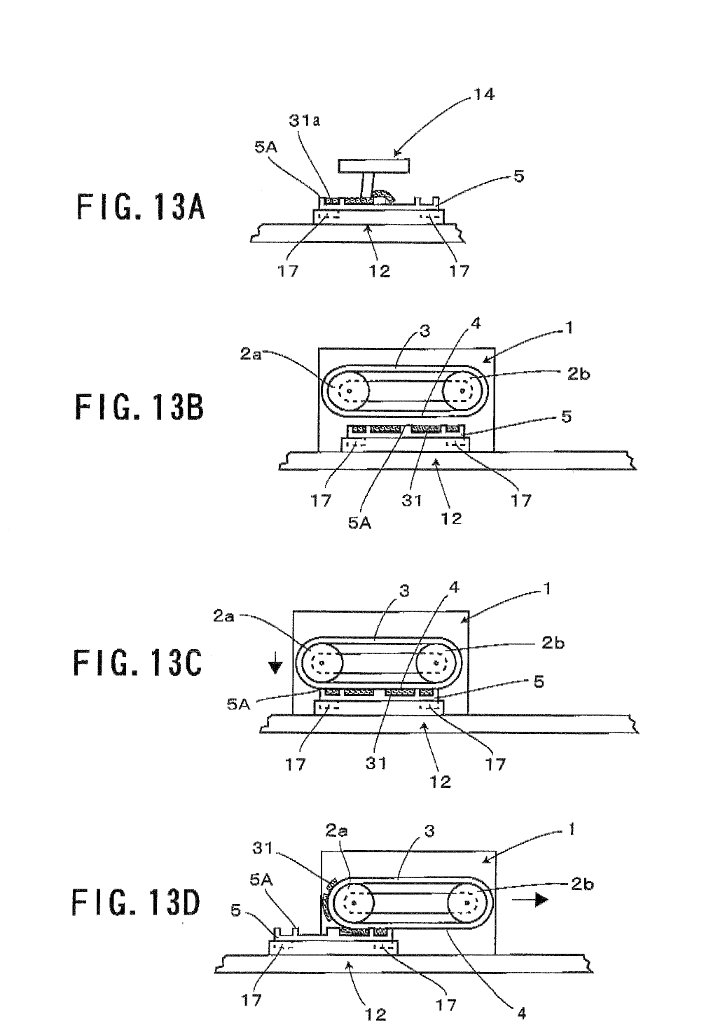

Next, the printing method according to the first embodiment using the printing apparatus shown in FIGS. 5 to 12 will be explained below with reference to FIGS. 13 to 18.

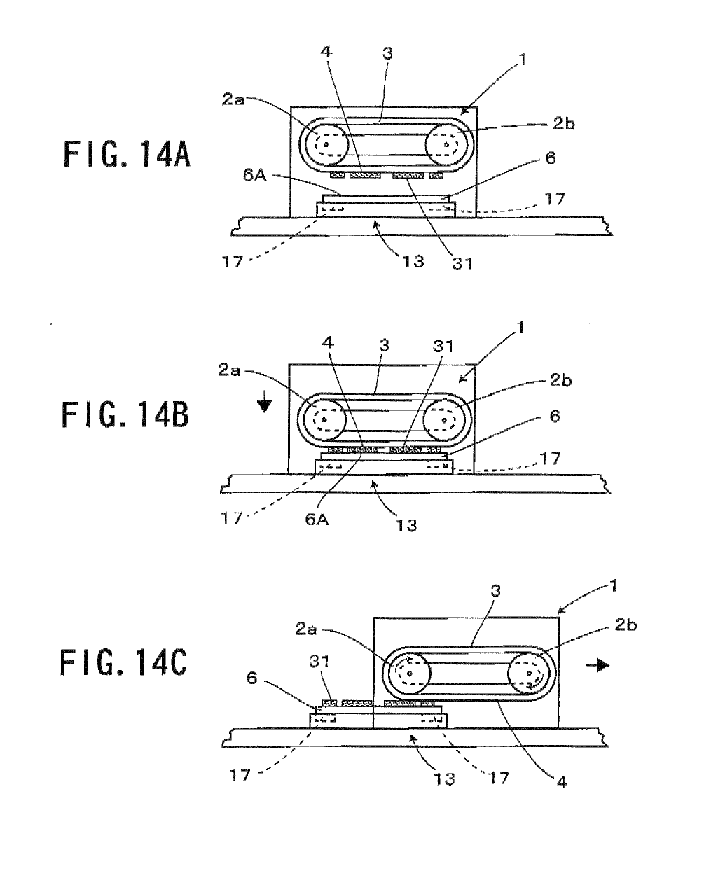

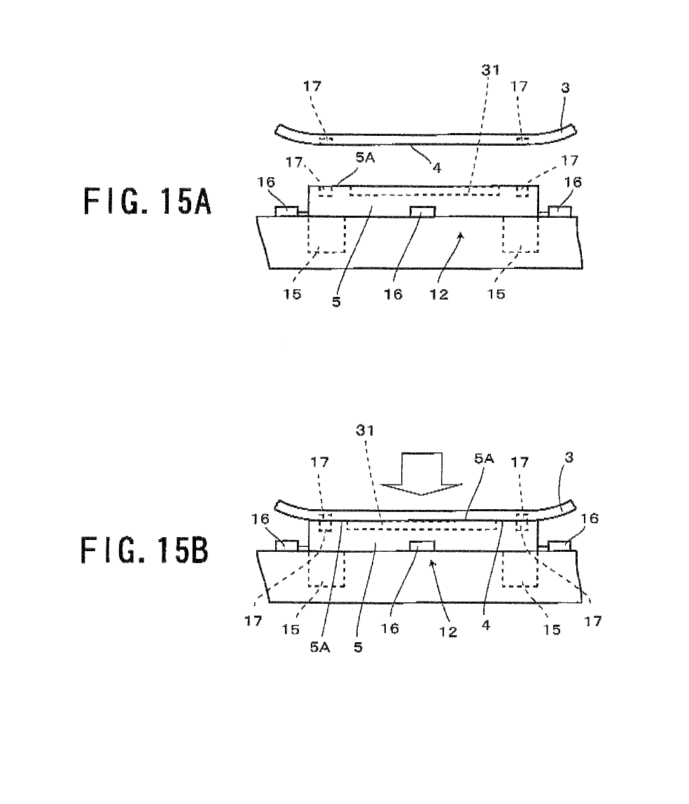

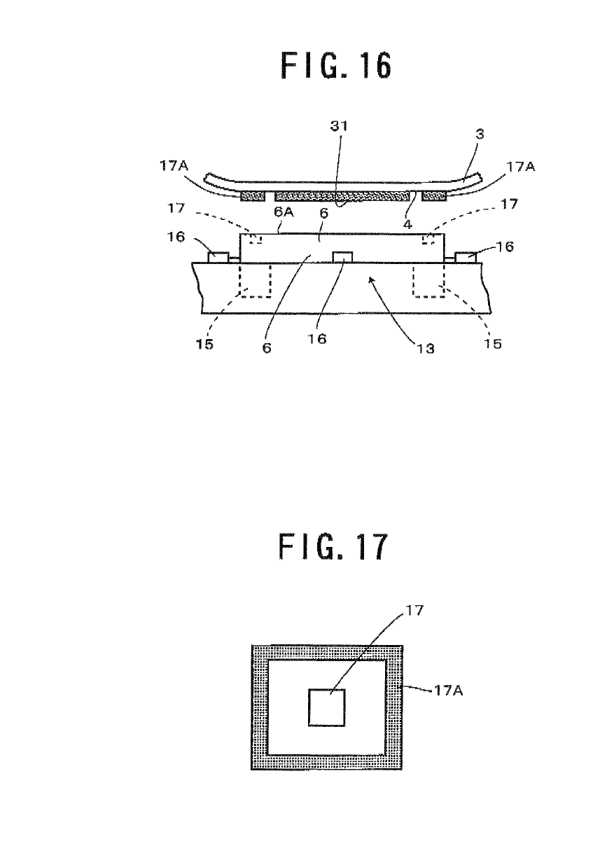

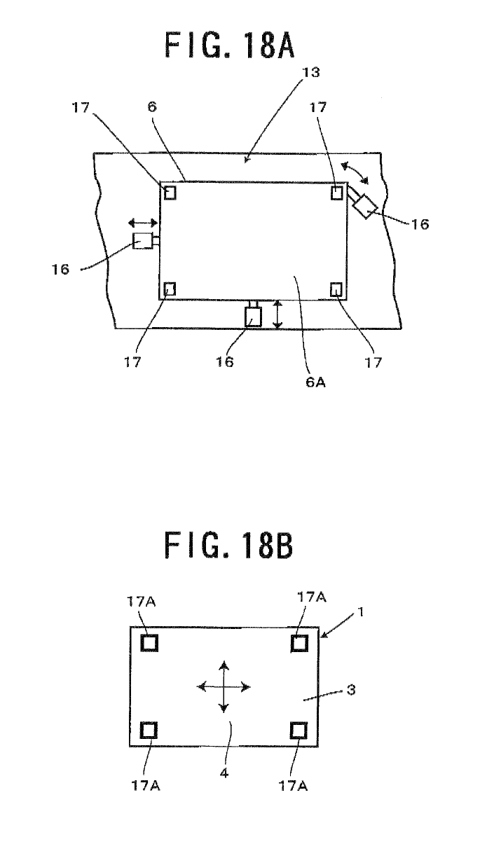

FIGS. 13A to 13D and FIGS. 14A to 14C are explanatory side views showing the printing processes of this method, respectively. FIGS. 15A and 15B are explanatory side views showing the positioning process of the printing plate 5 and the blanket 3, respectively. FIG. 16 is an explanatory side view showing the positioning process of the substrate 6 and the blanket 3. FIG. 17 is an explanatory plan view of the alignment marks 17 and 17A. FIG. 18A is an explanatory plan view of the substrate stage 13 and FIG. 18B is an explanatory bottom view of the transfer system 1.

If a substrate for a LCD device (e.g., a TFT substrate) is used as the substrate 6 in this printing method, the substrate for a LCD device is fabricated. Thereafter, if known fabrication processes are carried out using the substrate thus fabricated, a LCD device is fabricated.

First, as shown in FIG. 13A, the coating system 14 is moved to the position just over the printing plate stage 12 and then, ink 31a is coated on the surface of the printing plate 5 using the coating system 14. Since the desired pattern and the alignment marks 17 are formed on the surface of the printing plate 5 in advance, a desired pattern of the ink 31a (i.e., a desired ink pattern 31) is formed on the printing plate 5 along with the alignment marks 17 by coating the ink 31a. In FIG. 13A, the coating system 14 is of the squeezee type and the printing plate 5 is an intaglio printing plate. However, the printing plate 5 maybe a letterpress, intaglio, planographic, or flexographic printing plate. The ink pattern 31 may be first formed on the blanket 3 according to the type of printing; in this case, the ink 31a is coated on the blanket 3.

Next, as shown in FIG. 13B, after the coating system 14 is returned to its initial position (see FIG. 6), the transfer system 1 is moved to the position just over the printing plate 5. Then, the flat portion 5A of the printing plate 5 and the flat portion 4 of the blanket 3 are placed parallel at a predetermined interval, and the alignment operation between the printing plate 5 and the blanket 3 is carried out while keeping this parallel state. During this alignment operation, as shown in FIG. 15A, the alignment marks 17 disposed on the blanket 3 and the alignment marks 17 formed on the printing plate 5 in advance are read into the alignment cameras 15 disposed on the printing plate stage 12. Based on the position information thus obtained, the printing plate 5 is moved along X, Y, and/or θ direction(s) with the driving systems 16 in such a way that the alignment marks 17 on the blanket 3 and those on the printing plate 5 have a predetermined relationship. At the same time as this, the blanket 3 may be moved with the position correction system 23 mounted on the transfer system 1. This alignment operation is easily carried out because the marks 17 are disposed at three positions or more on the blanket 3 and the marks 17 are disposed at three positions or more on the printing plate 5, also.

After the alignment operation is completed, the flat portion 4 of the blanket 3 is lowered toward the flat portion 5A of the printing plate 5 while keeping the parallel state thereof unchanged. Thus, the flat portion 4 is brought into contact with the flat portion 5A, as shown in FIGS. 13C and 13B. At this time, the printing plate stage 12 may be raised toward the transfer system 1 instead of the blanket 3 being lowered.

Subsequently, as shown in FIG. 13D, the printing rollers 2a and 2b are rotated to thereby translate the transfer system 1 along the printing direction P. Due to the translation of the transfer system 1, the ink pattern formed on the printing plate 5 is transferred to the flat portion 4 of the blanket 3. In this transfer operation of the ink pattern 3, the ink pattern 3 is detached from the printing plate 5 by the part of the blanket 3 corresponding to the roller 2a located at the rear side (i.e., the opposite side to the printing direction P) of the transfer system 1. The aforementioned part of the blanket 3 is placed approximately right below the roller 2a. This means that the two flat portions 4 and 5A contacted with each other are gradually detached from their rear sides (from the left side in FIG. 13D). Here, after the ink pattern 31 is transferred to the flat portion 4 of the blanket 3, the ink pattern 31 is detached from the printing plate 5 at the rear part of the pattern 31 corresponding to the rear-side roller 2a. Therefore, the ink pattern 31 can be transferred at a constant detachment angle at all times.

When the type of printing is that the ink 31a is coated on the blanket 3, the unnecessary part of the ink 31a is removed from the blanket 3 by the printing plate 5, forming the desired ink pattern 31 on the blanket 3.

The diameters of the printing rollers 2a and 2b of the transfer system 1 may be freely determined in such a way as to generate an optimum detachment angle. For example, the diameters of the rollers 2a and 2b may be different. Alternately, a diameter-variable roller or rollers may be used. The printing speed may be set optionally.

In the first embodiment, the transfer system 1 is relatively moved with respect to the printing plate 5. However, the printing plate 5 may be relatively moved with respect to the transfer system 1. In this case, a similar transfer operation of the ink pattern 31 can be carried out.

Subsequently, the ink pattern 31 thus formed on the blanket 3 is transferred again to the substrate 6 in the following manner.

First, as shown in 14A, the transfer system 1 is moved to the position just over the substrate 6. Then, the flat portion 4 of the blanket 3 and the flat portion 6A of the substrate 6 are placed parallel at a predetermined interval, and the alignment operation between the blanket 3 and the substrate 6 is carried out in this parallel state in such a way that the ink pattern 31 on the blanket 3 is transferred (i.e., printed) to the substrate 6 at a desired position. This alignment operation is performed as follows:

As shown in 16, the alignment marks 17A formed by parts of the ink pattern 31 on the blanket 3 and the alignment marks 17 formed in advance on the substrate 6 are read into the alignment cameras 15 mounted on the substrate stage 13, thereby detecting a relative positional displacement between the blanket 3 and the substrate 6. This detection operation is easily carried out because the marks 17A are disposed at three positions or more on the blanket 3 and the marks 17 are disposed at three positions or more on the substrate 6 also. After the detection operation is completed, at least one of the blanket 3 and the substrate 6 is appropriately moved in such a way that the marks 17A on the blanket 3 and the marks 17 on the substrate 6 have a predetermined relationship. Thus, the alignment operation for the blanket 3 and the substrate 6 is carried out.

The substrate 6 is moved along the X, Y, and/or θ direction(s) according to the necessity by the driving systems 16 mounted on the substrate stage 13 (see FIG. 18A). The ink pattern 31 on the blanket 3 is moved along the X and/or Y direction(s) according to the necessity by rotating the printing rollers 2a and 2b (see FIG. 18B).

When the position correction system 23 is provided in the transfer system 1, the ink pattern 31 on the blanket 3 can be aligned to the predetermined position on the substrate 6 more easily. This is because minute deformation (i.e., fine adjustment) can be caused in the ink pattern 31 by giving external forces to the blanket 3 with the position correction system 23.

After the alignment operation between the alignment marks 17A on the blanket 3 and the alignment marks 17 on the substrate 6 is completed, the flat portion 4 is lowered toward the flat portion 6A while keeping their parallel state unchanged. Thus, similar to the alignment operation for the printing plate 5, the flat portion 4 of the blanket 3 is brought into contact with the flat portion 6A of the substrate 6, as shown in FIG. 14B.

Thereafter, as shown in FIG. 14C, the printing rollers 2a and 2b of the transfer system 1 are rotated to thereby translate the transfer system 1 along the printing direction P. Due to the translation of the transfer system 1, the ink pattern 31 formed on the blanket 3 is transferred onto the flat portion 6A of the substrate 6. In this transfer operation, the two flat portions 4 and 6A contacted with each other are gradually detached from their rear sides opposite to the printing direction P (from the left side in FIG. 14C) and as a result, the ink pattern 31 an the blanket 3 is transferred to the substrate 6. When the transfer of the entire ink pattern 31 is completed, the rotation of the rollers 2a and 2b is stopped and the said printing operation is completed.

In the said printing apparatus shown in FIGS. 5 to 12, one printing operation can be carried out without using the whole surface of the blanket 3 mounted in the transfer system 1; therefore, another similar printing operation can be started immediately using the unused surface of the blanket 3. Accordingly, the printing operation can be repeated continuously using the blanket 3 that has been dried for a certain time at all times without using the same surface of the blanket 3. This means that a plurality of printing operations can be carried oat successively without exchanging the blanket 3 for another blanket.

With the printing method according to the first embodiment, as explained above, the ink pattern 31 is first formed on the flat portion 4 of the blanket 3 using the printing plate 5 and then, the said ink pattern 31 is transferred to the substrate 6 from the blanket 3. In the formation operation of the ink pattern 31 on the blanket 3, the flat portion 4 of the blanket 3 and the flat portion 5A of the printing plate 5 are brought into contact in the state where they are opposed to each other at a predetermined interval, and thereafter, they are detached, thereby forming the ink pattern 31 on the flat portion 4 of the blanket 3. In this way, the blanket 3 and the printing plate 5 are contacted with each other at their flat portions 4 and 5A before the formation of the ink pattern 31 on the blanket 3, and as a result, the blanket 3 and the printing plate 5 are aligned in the state where the flat portions 4 and 5A are opposed. For this reason, the alignment operation between the blanket 3 and the printing plate 5 can be carried out easily and automatically and at the same time, highly accurate alignment (in other words, highly accurate positional adjustment) between them can be realized.

Moreover, in the transfer operation of the ink pattern 31 to the substrate 6, the flat portion 4 of the blanket 3 and the flat portion 6A of the substrate 6 are brought into contact in the state where they are opposed to each other at a predetermined interval, and thereafter, they are detached, thereby transferring the ink pattern 31 to the substrate 6 from the blanket 3. In this way, the blanket 3 and the substrate 6 are contacted with each other at their flat portions 4 and 6A before the transfer of the ink pattern 31 to the substrate 6 from the blanket 3, and as a result, the blanket 3 and the substrate 6 are aligned in the state where the flat portions 4 and 6A are opposed. For this reason, the alignment operation between the blanket 3 and the substrate 6 can be carried out easily and automatically and at the same time, highly accurate alignment (in other words, highly accurate positional adjustment) between them can be realized.

Furthermore, because the ink pattern 31 is transferred to the substrate 6 from the blanket 3 by contacting and detaching the flat portion 4 of the blanket 3 to the flat portion 6A of the substrate 6 in the state where they are opposed to each other, good transferability of the ink pattern 31 to the substrate 6 is obtainable. This means that good reproducibility of the ink pattern 31 is obtainable.

Accordingly, good reproducibility of the ink pattern 31 can be obtained and both of the alignment operation between the printing plate 5 and the blanket 3 and the alignment operation between the blanket 3 and the substrate 6 can be easily performed. As a result, the ink pattern transfer (i.e., the printing) with positional accuracy as high as the TFT substrate or the like can be fabricated is realizable.

In addition, with the said first embodiment, at least one of the flat portion 6A of the substrate 6 and the flat portion 4 of the blanket 3 can be deformed or displaced with the driving systems 16 in the alignment operations. Therefore, the alignment operations can be carried out more easily.

The transfer system 1 comprises the pair of printing rollers 2a and 2b, and the endless belt-shaped blanket 3 put around the rollers 2a and 2b, where the blanket 3 has the flat portion 4. Due to this shape of the blanket 3, not only the blanket 3 has a larger area or size than the printing plate 5 but also the successive use of the same surface of the blanket 3 is unnecessary. Therefore, the unused surface of the blanket 3 can be dried during the printing operation, which means that the swelling of the blanket 3 is easily prevented. In addition, because the swelling prevention of the blanket 3 is easy, the life of the blanket 3 is prolonged and as a result, the exchange frequency of the blanket 3 is decreased.

Since the pair of the rollers 2a and 2b of the transfer system 1 may be replaced with other rollers with different diameters as necessary, the detachment angle of the ink pattern 31 can be easily optimized by suitably selecting these diameters.

A desired pattern can be formed on the substrate 6 for the LCD device by the use of the above-described printing method according to the first embodiment. Therefore, a desired pattern can be formed on the substrate 6 with high positional accuracy. This means that the fabrication cost of the LCD device can be lowered if the LCD device is fabricated using the above-described printing method.

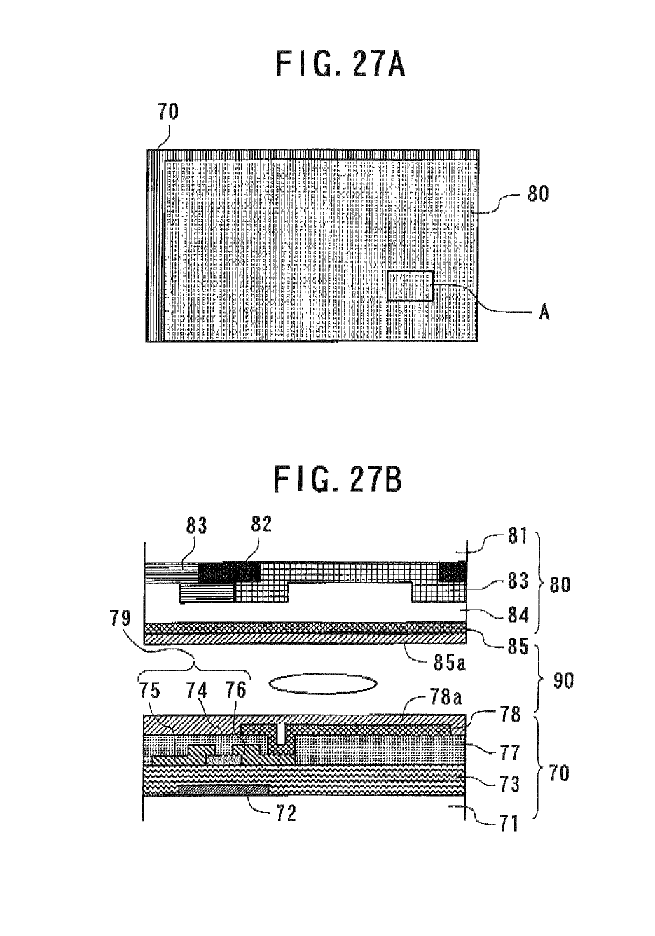

FIGS. 27A and 27B schematically show the typical structure of a LCD device to which the present invention is applied.

As shown in FIGS. 27A and 27B, this LCD device comprises a TFT substrate 70 on which TFTs 79 are arranged as the switching elements, a color filter substrate 80 on which a color filter 83 and a black matrix 82 are formed, and a liquid crystal layer 90 sandwiched by the TFT and color filter substrates 70 and 80. The alignment direction of the liquid crystal molecules in the liquid crystal layer 90 is changed, thereby controlling the amount of the transmitted light in each pixel to display desired images.

Regarding the TFT substrate 70, a gate electrode 72 is formed on the surface of a transparent glass plate 71. A gate insulating film 73 is formed on the glass plate 71 to cover the gate electrode 72. An island-shaped amorphous silicon (Si) film 74 is formed on the gate insulating film 73. A source electrode 75 and a drain electrode 76 are formed at each side of the amorphous Si film 74 to overlap with them, forming the TFT 79. A protective insulating film 77 is formed on the gate insulating film 73 to cover the TFT 79. A pixel electrode 78 is formed on the protective insulating film 77. The pixel electrode 78 is in contact with the drain electrode 76 by way of a contact hole of the protective insulating film 77. An alignment film 78a is formed on the protective insulating film 77 to cover the pixel electrode 78.

Regarding the color filter substrate 80, the black matrix 82 and the color filter 83 are formed on the surface of a transparent glass plate 81. An insulating film 84 is formed to cover the black matrix 82 and the color filter 83. A common or opposite electrode 85 is formed oil the insulating film 84. An alignment film 85a is formed to cover the opposite electrode 85.

The liquid crystal molecules in the liquid crystal layer 90 are in contact with the alignment films 78a and 85a.

Here, each of the TFT substrate 70 and the color filter substrate 80 is fabricated by the above-described printing method according to the first embodiment. However, any one of the TFT and color filter substrates 70 and 80 may be fabricated by this method.

### Second Embodiment

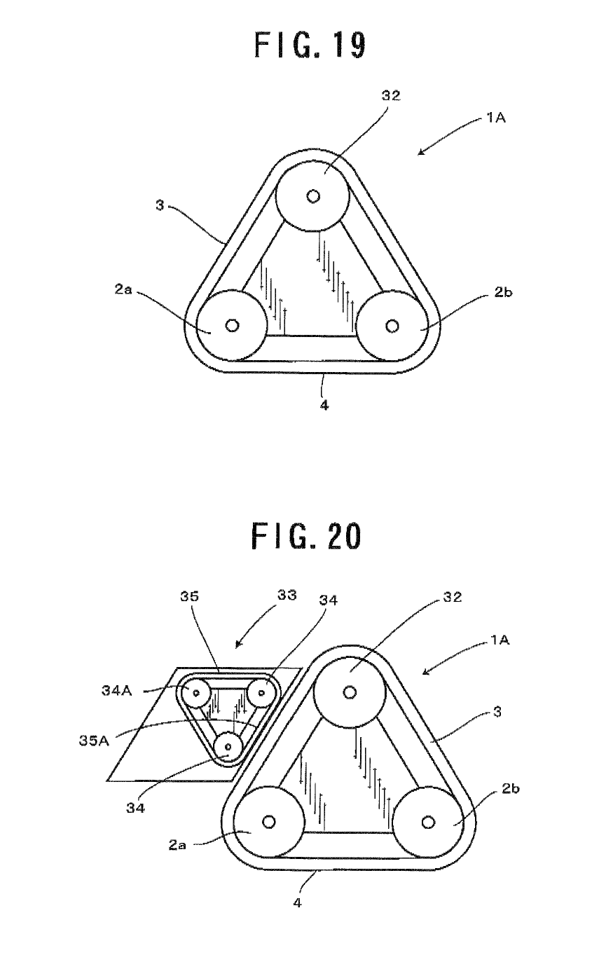

FIG. 19 is an explanatory side view showing the schematic structure of a transfer system 1A incorporated into a printing apparatus according to a second embodiment of the invention. FIG. 20 is an explanatory side view showing the schematic structure of the transfer system 1A, where a blanket drying system or mechanism 33 is added.

As shown in FIG. 19, the transfer system 1A according to the second embodiment comprises a blanket roller 32 in addition to the pair of printing rollers 2a and 2b. The rollers 2a and 2b and the blanket roller 32 are arranged at the three apices of a triangle, respectively. The endless belt-shaped blanket 3 is put around the printing rollers 2a and 2b and the blanket roller 32. Such the structure gives an advantage that the area or size of the blanket 3 provided in the transfer system 1A is enlarged compared with the aforementioned first embodiment.

With the second embodiment, one blanket roller 32 is provided; however, two or more blanket rollers may be provided. If the endless-belt-shaped blanket 3 can be put around, the layout of the pair of rollers 2a and 2b and the at least one blanket roller 32 is optionally determined. However, this layout needs to be determined in such a way as to produce the flat portion 4 with which the printing plate 5 or the substrate 6 is contacted in the printing operation.

A blanket drying system or mechanism 33 may be added to the transfer system 1A as shown in FIG. 20. The blanket drying system 33 comprises two guide rollers 34 and a guide roller 34A arranged respectively at the three apices of a triangle, and an endless belt-shaped solvent absorbent material 35 put around the guide rollers 34 and 34A. The solvent absorbent material 35 has a flat portion 35A between the two guide rollers 34. The blanket drying system 33 is movable toward the transfer system 1A.

If the drying operation is unnecessary, the blanket drying system 33 is kept at the position apart from the transfer system 1A, as shown in FIG. 20. If the drying operation is necessary, the blanket drying system 33 is moved toward the transfer system 1A, and the flat portion 35A of the system 33 is brought into contact with the blanket 3. In this contacting state, the solvent contained in the blanket 3 is absorbed into the solvent absorbent material 35 thus contacted with the blanket 3 and therefore, the blanket 3 can be dried. Since the solvent absorbent material 35 is endless belt-shaped, it is rotated around the guide rollers 34 and 34A along with the rotation of the blanket 3.

Although the solvent absorbent material 35 is used for drying the blanket 3 here, any type of drying system may be used for this purpose. For example, air may be blown to the surface of the blanket 3 for drying the said surface.

With the printing apparatus according to the second embodiment, as explained above, the transfer system 1A comprises the at least one blanket roller 32 in addition to the pair of printing rollers 2a and 2b and therefore, the area or size of the blanket 3 provided in the transfer system 1A can be enlarged.

Moreover, if the blanket drying system 33 is additionally provided, the unused surface of the blanket 3 can be dried without affecting the tact time even in the printing operation. Since the blanket 3 may be dried in every fixed period, the swelling of the blanket 3 can be minimized and at the same time, the surface condition of the blanket 3 can be kept approximately the same at all times. This means that the reproducibility of the ink pattern 31 is enhanced furthermore.

Further, because the solvent absorbent material 35 and the blanket 3 are easily contacted with each other on their surfaces, the drying time can be made longer and the damage of the surface of the blanket 3 induced by friction can be minimized.

### Third Embodiment

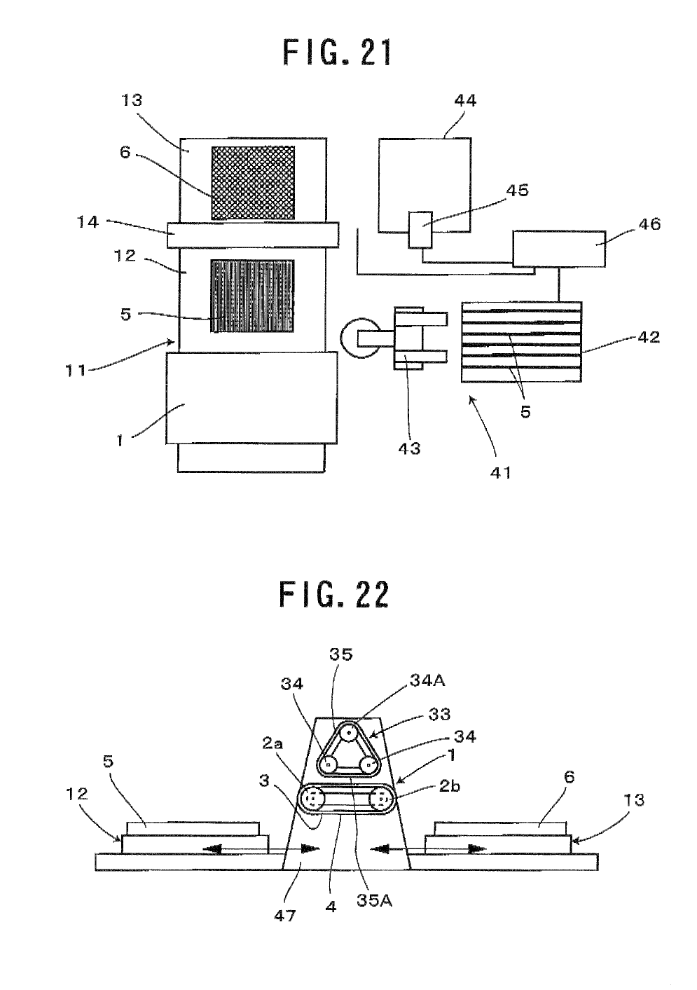

FIG. 21 shows a printing apparatus according to a third embodiment of the invention. This apparatus has a structure corresponding to the combination of a printing plate exchange system 41 and the structure of the above-described printing apparatus according to the first embodiment. With the printing apparatus of the third embodiment, the printing plate 5 fixed to the printing plate stage 12 can be automatically exchanged for another printing plate during the printing operation.

The printing plate exchange system 41 comprises a printing plate stock section 42 and a printing plate transport system 43, as shown in FIG. 21. The printing plate stock section 42 stocks a plurality of kinds of the printing plates 5. The printing plate transport system 43 selects one of the printing plates 5 stocked in the printing plate stock section 42, and transports the printing plate 5 thus selected to the printing plate stage 12. Moreover, the printing plate transport system 43 takes the printing plate 5 out of the printing plate stage 12, and stocks the printing plate 5 thus taken in the printing plate stock section 42. In FIG. 21, an arm robot that holds the printing plate 5 by nipping or sucking and transports it between the printing plate stock section 42 and the printing plate stage 12 is shown as the printing plate transport system 43.

In the vicinity of the substrate stage 13, a substrate cassette section 44 for stocking the substrates 6, a first substrate transport system (not shown), and a second substrate transport system (not shown) are provided. The substrate cassette section 44 stocks the substrate 6 on which an ink pattern is not yet printed (i.e., the pre-print substrate). The first substrate transport system takes one of the pre-print substrates 6 stocked in the substrate cassette section 44 and transports it to the substrate stage 13. The second substrate transport system takes the substrate 6 on which an ink pattern is already printed (i.e., the post-print substrate) from the substrate stage 13 and transports it to the outside. A code reader 45 is provided in the substrate cassette section 44. The code reader 45 is a means for recognizing the kind of the printing plate 5 to be brought into the substrate stage 13 next in accordance with the kind of the substrate 6 placed on (i.e., transported into) the substrate stage 13 and the kind of a pattern to be formed thereon.

When the code reader 45 recognizes the kind of the printing plate 5 to be brought into the substrate stage 13 next time using the code attached to the said printing plate 5, the reader 45 sends the data thus recognized to a controller 46. The controller 46 discriminates the kind of the printing plate 5 to be brought into next based on the recognized data thus sent, and notifies the recognized kind of the printing plate 5 to the printing plate transport system 43. In response to the notification from the controller 43, the printing plate transport system 43 takes the printing plate 5 corresponding to the pattern to be printed on the substrate 6 that is currently fixed on the substrate stage 13 from the substrate cassette section 44, and then, transports it to the printing plate stage 12. The printing plate 5 thus transported is fixed on the printing plate stage 12.

After the printing operation is completed, the printing plate transport system 43 takes the next printing plate 5 that is required for the next printing operation from the substrate cassette section 44 and then, transports it to the printing plate stage 12 in a similar manner. The printing plate 5 thus transported is fixed on the printing plate stage 12.

With the printing apparatus according to the third embodiment, as explained above, the printing plate 5 can be automatically exchanged for another with the printing plate exchange system 41. Therefore, there is an advantage that this apparatus can be preferably used for fabrication of the TFT substrate for the LCD device or the like. For example, not only the repetitive printing of the same pattern but also the alternate printing of different patterns according to the fabrication process and the device type need to be carried out in the fabrication process of the TFT substrate. For this reason, it is necessary to exchange the printing plate 5 for another frequently. However, since the printing apparatus of the third embodiment comprises the printing plate exchange system 41, the required printing plate 5 can be discriminated instantly and placed on the printing plate stage 12 in response to the kind of the substrate 6 mounted on the substrate stage 13. Accordingly, the printing plate 5 can be automatically exchanged for another without degrading the tact time in fabrication, thereby forming a variety of kinds of the ink patterns 31 on the substrates 6.

### Fourth Embodiment

FIG. 22 shows the schematic structure of a printing apparatus according to a fourth embodiment of the invention.

This printing apparatus comprises a machine support 47 mounted between the printing plate stage 12 and the substrate stage 13. The machine support 47 sustains the transfer system 1 used in the printing apparatus of the above-described first embodiment (see FIG. 5). The transfer system 1 is positioned in such a way that the flat portion 4 of the blanket 3 is approximately horizontal.

The blanket drying system 33 used in the printing apparatus of the above-described second embodiment (see FIG. 20) is sustained by the machine support 47 at a position above the transfer system 1. The blanket drying system 33 is movable upward and downward. When the blanket 3 is to be dried, the blanket drying system 33 is lowered such that the flat portion 35A of the endless belt-shaped solvent absorbent material 35 is brought into contact with the upper surface of the blanket 3 opposite to the flat portion 35A.

The printing plate stage 12 and the substrate stage 13, which are located at each side of the transfer system 1, are movable horizontally along the printing direction P and the opposite direction thereto. The printing plate stage 12 is stopped at the middle position just below the transfer system 1 and thereafter, the printing plate stage 12 is elevated or the transfer system 1 is lowered; thus, the flat portion 4 of the blanket 3 and the flat portion 5A of the printing plate 5 are brought into contact with each other. Following this, the blanket 3 is rotated while the printing plate stage 12 is shifted horizontally. Thus, the ink pattern 31 is transferred to the flat portion 4 of the blanket 3 from the printing plate 5.

Subsequently, the printing plate stage 12 is moved to the left side position with respect to the machine support 47 from the middle position just below the transfer system 1. Instead, the substrate stags 13 is moved from the right side position to the middle position and stopped and elevated or the transfer system 1 is lowered. Thus, the flat portion 4 of the blanket 3 and the flat portion 6A of the substrate 6 are brought into contact with each other. Following this, the blanket 3 is rotated while the substrate stage 13 is shifted horizontally. Thus, the ink pattern 31 is transferred to the flat portion 6A of the substrate 6 from the flat portion 4 of the blanket 3.

After the transfer of the ink pattern 31 to the substrate 6 from the blanket 3 is completed, the substrate stage 13 is moved to the right side position with respect to the machine support 47 from the middle position just below the transfer system 1. In this way, one cycle of the printing operation (i.e., the printing operation for one pattern) is finished.

With the printing apparatus according to the fourth embodiment, the amount of the driving mechanisms (operating members or parts) of the transfer system 1 moved over the substrate 6 or printing plate 5 is decreased as small as possible. Therefore, the dust occurring in the printing operation can be minimized.

Moreover, since the transfer system 1 is not moved horizontally and vertically at all or it is simply moved vertically for short distances, the installation and maintenance of the blanket drying system 33 are easily carried out. For this reason, the ease of maintenance is improved and the fabrication yield can be prevented from lowering.

### Fifth Embodiment

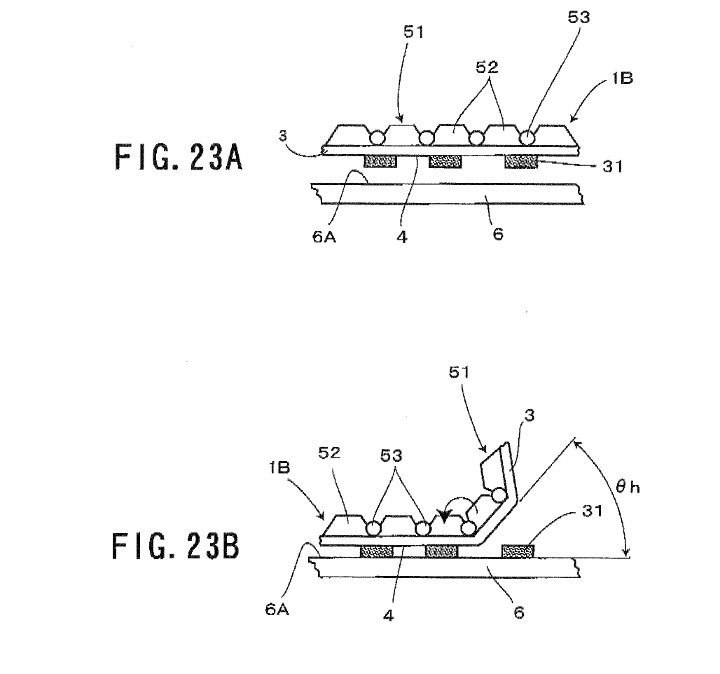

FIG. 23A is a partial cross-sectional view showing the schematic structure of the transfer system 1B incorporated into a printing apparatus according to a fifth embodiment of the invention, and FIG. 23B is a partial cross-sectional view showing the deformed state of the blanket 3 of the transfer system 1B.

With the transfer system 1B according to the fifth embodiment, as shown in FIGS. 23A and 23B, the blanket mounting element or part, by which the endless belt-shaped blanket 3 is put around the pair of printing rollers 2a and 2b, is an endless or continuous belt member 51. The belt member 51 (i.e., the blanket mounting element) is formed by a set of rod-shaped blocks 52. In other words, the belt member 51 is divided into the blocks 52. Each of the blocks 52 may be rocked within a predetermined angle around a pin connecting part 53 placed at each side of the said block 52. As shown in FIG. 23B, the blocks 52 may be turned to a predetermined angle around the pin connecting part 53 by a driving device (not shown).

Concretely speaking, the set of rod-shaped blocks 52 are assembled with the pin connecting parts 53 to thereby form the endless belt member 51. The endless belt-shaped blanket 3 is attached onto the periphery of the endless belt member 51. The two rod-shaped blocks 52 adjacent to each other may be rocked around the respective pin connecting parts 53. The block 52 located at a desired position can be set at a predetermined angle with respect to an adjoining one of the pin connecting parts 53 by the operation of the driving device, as shown in FIG. 23B. The angle defined in this way is the detachment angle θh. As seen from FIG. 23B, the detachment angle θh is an angle between the flat portion 6A of the substrate 6 and the surface of the blanket 3 bent along the corresponding block 52 of the belt member 51. As the driving devices for rocking the rod-shaped blocks 52, small-scale motors (not shown) provided at the pin connecting parts 53 may be used.

The value of the detachment angle θh may be optionally set; however, it is preferred that the detachment angle θh is set in the range from 20° to 40° (i.e., 20°<θh<40°).

When the transfer system 1B according to the fifth embodiment is used, since the blanket mounting element is formed by the endless belt member 51, the ink pattern 31 can be smoothly detached and transferred (i.e., printed) at the constant detachment angle θh at all times by deforming the part of the belt member 51 using the driving devices. Moreover, since the size of the transfer system 1B is minimized, two or more transfer systems 1B may be easily provided in the printing apparatus.

The position correction system 23 for correcting the position of the ink pattern 31 on the blanket 3, which is used in the above-described first embodiment, may be added to the transfer system 1B. Although the endless belt 51 formed by the assembly of the rod-shaped blocks 52 is used as the blanket mounting element in FIGS. 19A and 19B, a uniform endless (which is not divided into the blocks 52) belt may be used for this purpose if the angle of the blanket 3 can be changed to a desired value at a desired position during the printing operation.

### Sixth Embodiment

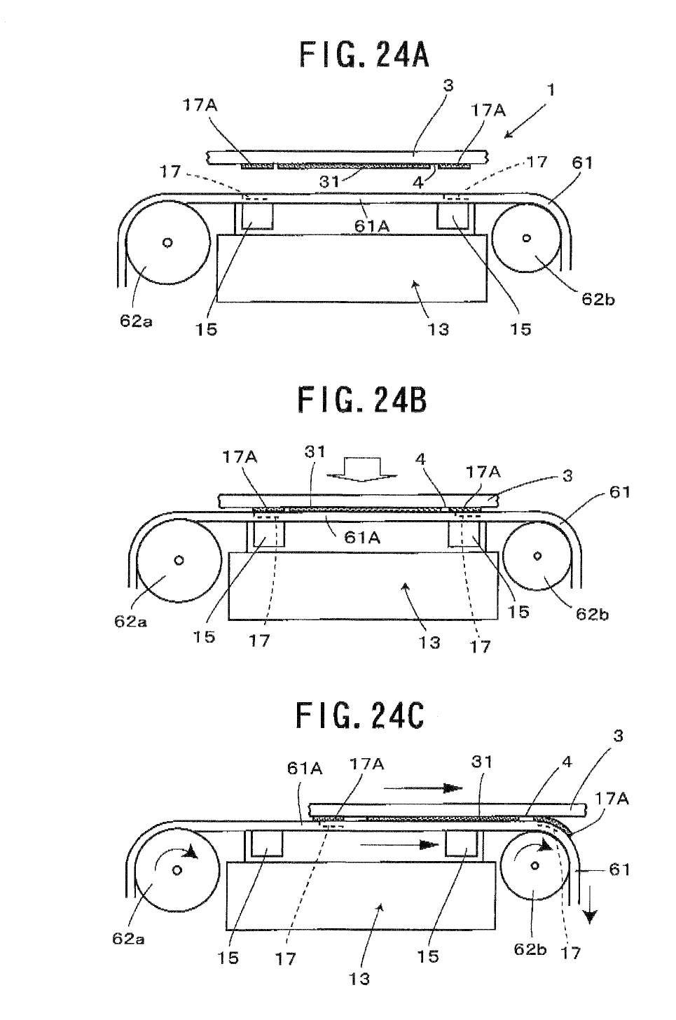

FIGS. 24A to 24C are explanatory partial cross-sectional views of the vicinity of the blanket 3 and the substrate stage 13, respectively, showing the printing step (printing method) of a printing apparatus according to a sixth embodiment of the invention, respectively. This embodiment is an example where the ink pattern 31 is printed on a flexible substrate 61.

A pair of substrate support rollers 62a and 62b is disposed along the printing direction P at a predetermined interval in the substrate stage 13. The substrate support rollers 62a and 62b are rotated by a driving device (not shown). The flexible substrate 61 is supported by the rollers 62a and 62b, as shown in FIG. 24A. The part of the substrate 61 held horizontally between the rollers 62a and 62b is a flat portion 61A. A pair of alignment cameras 15 is provided under the substrate 61 between the rollers 62a and 62b. The substrate 61 has pairs of alignment marks 17 formed at predetermined intervals along the longitudinal direction of the substrate 61, where the alignment marks 17 are arranged at the corresponding positions to the alignment cameras 15.

The flat portion 61A of the flexible substrate 61 is moved or transported horizontally between the support rollers 62a and 62b. Since the substrate 61 is transported downward at approximately right angle to the printing direction P (i.e., the transportation direction) by the roller 62b placed at the carry out side, the substrate 61 is separated from the blanket 3 at the position where the transportation direction is changed downward. Therefore, the ink pattern 31 on the blanket 3 is detached at that position from the blanket 3.

In the printing operation, as shown in FIG. 24A, the alignment operation between the flexible substrate 61 and the blanket 3 is carried out in the state where the flat portion 61A and the flat portion 4 are opposed to each other. At this time, the alignment marks 17 on the substrate 61 and the alignment marks 17A in the ink pattern 31 are respectively aligned using the alignment cameras 15.

After the alignment operation is completed, as shown in FIG. 24B, the blanket 3 is lowered and then, the flat portion 4 of the blanket 3 is brought into contact with the flat portion 61A of the substrate 61.

Subsequently, the substrate 61 and the blanket 3 are moved along the printing direction P in synchronization with each other. Then, as shown in FIG. 24C, the substrate 61 is bent along the curved surface of the roller 62b placed at the carry out side. Thus, the substrate 61 is detached from the blanket 3 at the desired detachment angle and as a result, the ink pattern 31 on the blanket 3 is transferred to the substrate 61. The diameters of the rollers 62a and 62b may be optionally determined to optimize the detachment angle.

It is unnecessary that the blanket 3 used in the transfer system 1 of the printing apparatus of the sixth embodiment is endless belt-shaped; the blanket 3 may have a structure including the flat portion 4A only. This is because the ink pattern 31 can be detached from the blanket 3 at the desired detachment angle due to the transportation of the substrate 61. If the endless belt-shaped blanket 3 as explained in the first embodiment is used, the printing operation is carried out without rotating the printing rollers 2a and 2b. However, the printing operation may be carried out while the printing rollers 2a and 2b are rotated. In this case, the ink pattern 31 is detached from both the blanket 3 and the substrate 61. A flexible printing plate 5 similar to the flexible substrate 61 may be used.

With the printing apparatus according to the sixth embodiment, as explained above, the flat portion 4 of the blanket 3 is contacted with the flat portion 61A of the flexible substrate 61 in the state where the flat portion 61A is held approximately horizontally between the substrate support rollers 62a and 62b, and thereafter, the substrate 61 and the blanket 3 are transported horizontally in synchronization with each other. Subsequently, due to the change of the transportation direction of the substrate 61 at the roller 62b placed at the carry out side, the desired detachment angle is generated for the ink pattern 31 on the blanket 3, thereby printing (i.e., transferring) the ink pattern 31 onto the flexible substrate 61 from the blanket 3. Accordingly, the printing operation of the ink pattern 31 to the flexible substrate 61 can be carried out in its continuous form without dividing the substrate 61. In addition, this printing operation can be smoothly performed.

### Seventh Embodiment

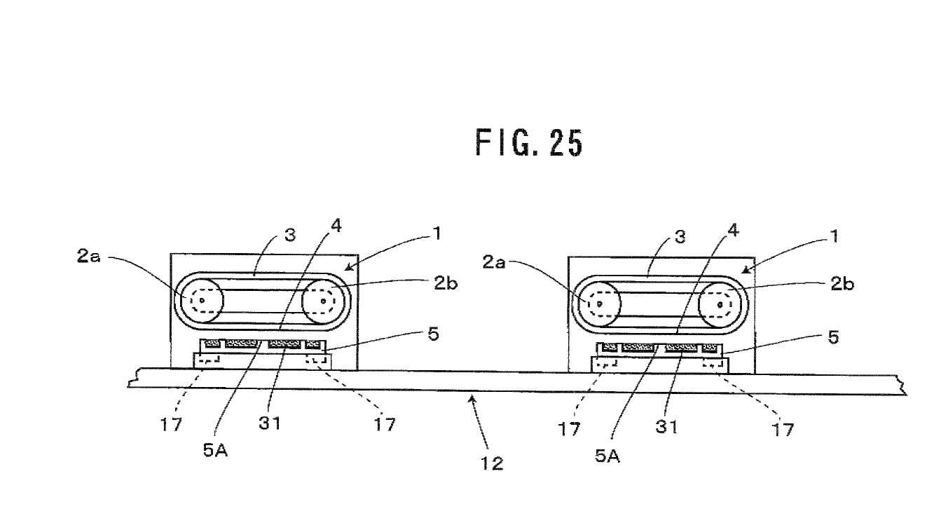

FIG. 25 shows the structure of the vicinity of the blanket 3 and the printing plate stage 12 of a printing apparatus according to a seventh embodiment of the invention.

This printing apparatus is configured in such a way as to place the two printing plates 5 on the printing plate stage 12, where the two transfer systems 1 used in the first embodiment are provided corresponding to the printing plates 5. Needless to say, the number of the printing plates 5 placed on the printing plate stage 12 may be three or more.

With the printing apparatus according to the seventh embodiment, as explained above, the printing plate stage 12 comprises the two printing plates 5 and the two transfer systems 1. Therefore, by selecting one of the printing plates 5 to use the selected one or by using both the printing plates 5 simultaneously, the printing operation can be carried out efficiently.

### Eighth Embodiment

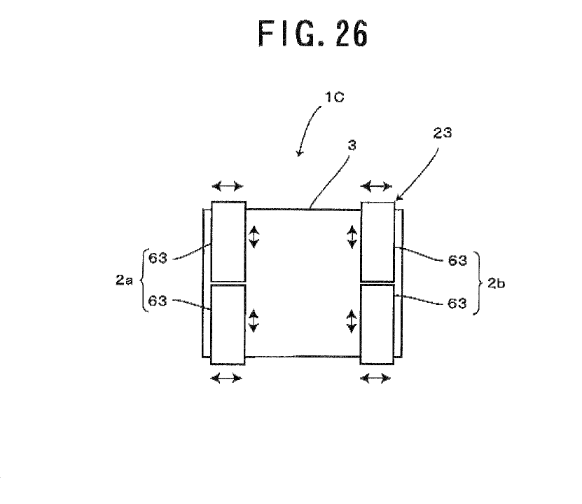

FIG. 26 shows the structure of the transfer system 1C used in a printing apparatus according to an eighth embodiment of the invention.

With the transfer system 1C, as shown in FIG. 26, each of the printing rollers 2a and 2b is divided into two parts, in other words, each of the rollers 2a and 2b is formed by two sub-rollers 63 (i.e., two divided rollers). The two sub-rollers 63 for the roller 2a or 2b are placed at a narrow gap along their common rotation axis. The position of each sub-roller 63 is independently adjustable by the position correction system 23 used in the aforementioned first embodiment. External forces can be applied to the blanket 3 along the X, Y, and/or θ direction(s) by changing the positions of the respective sub-rollers 63, thereby adjusting the position of the blanket 3.

With the transfer system 1C of the printing apparatus according to the eighth embodiment, each of the printing rollers 2a and 2b is formed by the combination of the two sub-rollers 63, the position of the blanket 3 can be corrected by independently displacing the sub-rollers 63.

### Other Embodiments

The above-described first to eighth embodiments are preferred examples of the present invention. Therefore, needless to say, the present invention is not limited to these embodiments and any modification is applicable to them.

For example, the printing rollers may be toothed rollers and the blanket may have grooves or teeth that engage with the teeth of the said rollers in its inner surface. Moreover, the alignment marks on the blanket may be formed in advance on or in the blanket. The alignment marks on the blanket may be formed utilizing a part or parts of the ink pattern transferred from the printing plate.

While the preferred forms of the present invention have been described, it is to be understood that modifications will be apparent to those skilled in the art without departing from the spirit of the invention. The scope of the present invention, therefore, is to be determined solely by the following claims.

What is claimed is:

1. A printing method for printing an ink pattern, which is formed on a blanket using a printing plate, to a substrate;
said method comprises the steps of:
providing a flat portion of the blanket;
contacting the flat portion of the blanket an ink pattern formed in a flat portion of the printing plate in their opposing state and detaching the flat portions from each other, thereby transferring the ink pattern to the flat portion of the blanket; and
contacting the flat portion of the blanket with the transferred ink pattern a flat portion of the substrate in their opposing state and detaching the flat portions from each other, thereby transferring the ink pattern to the substrate from the blanket.

2. The method according to claim 1, wherein before the flat portions of the blanket and the printing plate are contacted with each other in their opposing state, at least one of the flat portions of the blanket and the printing plate is deformed or moved and thereafter, the flat portions are aligned.

3. The method according to claim 1, wherein before the flat portions of the blanket and the substrate are contacted with each other in their opposing state, at least one of the flat portions of the blanket and the substrate is deformed or moved and thereafter, the flat portions are aligned.

4. The method according to claim 1, wherein three or more alignment marks are formed on each of the printing plate, the blanket, and the substrate: and
the alignment marks on the blanket are used in both blanket-printing plate alignment and blanket-substrate alignment.

5. The method according to claim 1, wherein when detaching the flat portion of the blanket and the flat portion of the printing plate from each other, an angle between the flat portion of the blanket and the flat portion of the printing plate is changed by deforming the blanket, thereby generating a desired detachment angle.

6. The method according to claim 1, wherein the blanket is an endless belt-shaped and is put around two rotatable rollers; and
the flat portion of the blanket is formed between the rollers.

7. The method according to claim 1, wherein an unused surface of the blanket is dried with a blanket drying system.

8. The method according to claim 1, wherein a flexible substrate is used as the substrate;
the flexible substrate is transportable between a pair of substrate support rollers and comprises a flat portion between the pair of substrate support rollers; and
the flat portion of the blanket is contacted with the flat portion of the flexible substrate, thereby transferring the ink pattern on the blanket to the flexible substrate.

9. The method according to claim 1, wherein the ink pattern is transferred from the printing plate to the substrate by way of the blanket using a plurality of the printing plates simultaneously or while exchanging a plurality of the printing plates.

10. A printing apparatus for printing an ink pattern, which is formed on a blanket using a printing plate, to a substrate;
said apparatus comprising:
a transfer system comprising a blanket with a flat portion;
an ink pattern formation system for forming an ink pattern on the flat portion of the blanket in cooperation with the transfer system by contacting the flat portion of the blanket with a flat portion of the printing plate in their opposing state and detaching the flat portions from each other; and
an ink pattern transfer system for transferring the ink pattern to the substrate from the blanket in cooperation with the transfer system by contacting the flat portion of the blanket with a flat portion of the substrate in their opposing state and detaching the flat portions from each other.

11. The apparatus according to claim 10, further comprising a position correction system;
wherein before the flat portions of the blanket, the printing plate, or the substrate are contacted each other in their opposing state, at least one of the flat portions of the blanket, the printing plate, or the substrate is deformed or moved and thereafter, the flat portions are aligned by the position correction system.

12. The apparatus according to claim 10, wherein three or more alignment marks are formed on each of the blanket and the printing plate; and
the flat portion of the blanket and the flat portion of the printing plate are aligned using the alignment marks.

13. The apparatus according to claim 10, wherein three or more alignment marks are formed on each of the blanket and the substrate; and
the flat portion of the blanket and the flat portion of the substrate are aligned using the alignment marks.

14. The apparatus according to claim 10, wherein three or more alignment marks are formed on each of the printing plate, the blanket, and the substrate; and
the alignment marks on the blanket are used in both blanket-printing plate alignment and blanket-substrate alignment.

15. The apparatus according to claim 10, further comprising a printing plate stage on which the printing plate is placed; and
a substrate stage on which the substrate is placed:
wherein when the ink pattern is formed on the flat portion of the blanket, the blanket or the printing plate stage is moved to generate a state where the flat portion of the blanket and the flat portion of the printing plate are opposed; and
when the ink pattern is transferred to the substrate from the blanket, the blanket or the substrate stage is moved to generate a state where the flat portion of the blanket and the flat portion of the substrate are opposed.

16. The apparatus according to claim 10, further comprising a blanket deformation mechanism;
wherein when detaching the flat portion of the blanket and the flat portion of the printing plate from each other, an angle between the flat portion of the blanket and the flat portion of the printing plate is changed by deforming the blanket using the blanket deformation mechanism, thereby generating a desired detachment angle.

17. The apparatus according to claim 10, wherein the blanket is an endless belt-shaped and is put around two rotatable rollers; and
the flat portion of the blanket is formed between the rollers.

18. The apparatus according to claim 17, wherein each of the rollers is formed by a plurality of sub-rollers.

19. The apparatus according to claim 10, wherein the transfer system comprises at least one blanket roller.

20. The apparatus according to claim 10, further comprising a blanket drying system for drying the unused flat portion of the blanket.

21. The apparatus according to claim 10, further comprising a pair of substrate support rollers for transporting the flexible substrate to have a predetermined tension;
wherein the flat portion of the substrate is formed between the pair of substrate support rollers.

22. The apparatus according to claim 10, further comprising a printing plate exchanging system for exchanging the printing plate for another printing plate;
wherein the ink pattern is transferred from the printing plate to the substrate by way of the blanket while exchanging the printing plate for another printing plate with the printing plate exchanging system.

23. A liquid crystal display device including;
an ink pattern printed by the printing method according to claim 1.
